(19) United States
(12) Patent Application Publication
(10) Pub. No.: US 2017/0316381 A1
(43) Pub. Date: Nov. 2, 2017

(54) SYSTEMS AND METHODS FOR PATIENT TEST MANAGEMENT

(71) Applicant: CLEARSTAR, INC., Alpharetta, GA (US)

(72) Inventors: Kenneth W. Dawson, JR., Covington, GA (US); Lydia Marie Wray, Overland Park, KS (US); Todd Irwin Shoulberg, Palm Bay, FL (US)

(73) Assignee: CLEARSTAR, INC., Alpharetta, GA (US)

(21) Appl. No.: 15/583,567

(22) Filed: May 1, 2017

Related U.S. Application Data
(60) Provisional application No. 62/330,573, filed on May 2, 2016.

(51) Int. Cl. G06Q 10/10; G06Q 50/22; G06Q 10/06

(52) U.S. Cl. CPC G06Q 10/1053; G06Q 10/06398; G06Q 50/22

(57) ABSTRACT

Disclosed herein are systems, devices, and methods that are directed to coordinating the administration of various tests, for example, drug tests, clinical tests, and/or medical tests by a screening computer system. The tests can be performed at various sites (for example, the collection site(s), lab(s), clinical testing site(s), medical testing site(s), medical review office(s), and the like). In various example embodiments, the screening computer system can exchange information between one or more computers at the various sites and a user device, for example, a cell phone associated with a patient, or a computer associated with a site, for example, a collection site.

### RELATED APPLICATIONS

This application claims the benefit under 35 U.S.C. §119 to U.S. Provisional Patent Application No. 62/330,573, titled “Systems and Methods for Patient Test Management,” filed on May 2, 2016, the disclosure of which is incorporated herein by reference in its entirety.

### TECHNICAL FIELD

This disclosure is generally directed to test management and more specifically to systems and methods managing testing procedures between a prospective employee and one or more testing facilities.

### BACKGROUND

Employee turnover can place a substantial strain on employer resources. Thus, obtaining quality employees at the outset becomes more critical. Identifying and keeping employees who are qualified and safe to do the job can include conducting medical testing (for example, drug testing, stress testing, physicals, and the like) and background checks. Further, some employment positions can require periodic testing to determine the ongoing safety and health of the employee in order to satisfy local, state, and/or federal requirements. Scheduling and monitoring the testing process is both time consuming and costly. Delays by the employer can result in the loss of an opportunity to hire a qualified employee or the loss of an employee's ability to do their job, both of which can negatively affect the employer. Further, such medical testing and/or background checks may require the exchange of information between several different entities, which may involve delays, human error, erroneous transmissions to wrong entities, mismanagement, lack of optimization, the generation of extraneous paperwork, security issues, and the like. Moreover, the exchange of such information may be carried out using communication methods such as telephone calls, emails, text messages, instant messages, fax messages, in-person meetings, and the like. This can lead to inefficiencies regarding when and where information is received, as well as inefficiencies in acting upon information once it is received.

### BRIEF DESCRIPTION OF THE DRAWINGS

Reference will now be made to the accompanying drawings, which are not necessarily drawn to scale, and wherein:

FIG. 1 shows an example diagram of a test subject screening computing system in accordance with example embodiments of the disclosure.

FIG. 2 shows a diagram of an example test subject device showing a user interface screen generated by the screening computing system in accordance with example embodiments of the disclosure.

FIGS. 3A and 3B illustrate an example method for scheduling test subject screenings in accordance with one example embodiment of the disclosure.

FIG. 4 illustrates an example method of receiving status updates and results of a screening of a test subject in accordance with one example embodiment of the disclosure.

FIG. 5 is an overview of a system that can be used to practice embodiments of the present disclosure.

FIG. 6 is an example schematic diagram of a screening computing system according to one example embodiment of the disclosure.

FIG. 7 is an example schematic diagram of a test subject or relations computing entity according to one example embodiment of the disclosure.

### DETAILED DESCRIPTION OF EXAMPLE EMBODIMENTS

Various embodiments of the present disclosure now will be described more fully hereinafter with reference to the accompanying drawings, in which example embodiments are shown. However, these example embodiments may be embodied in many different forms and should not be construed as limited to the example embodiments set forth herein; rather, these example embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like, but not necessarily the same, elements throughout.

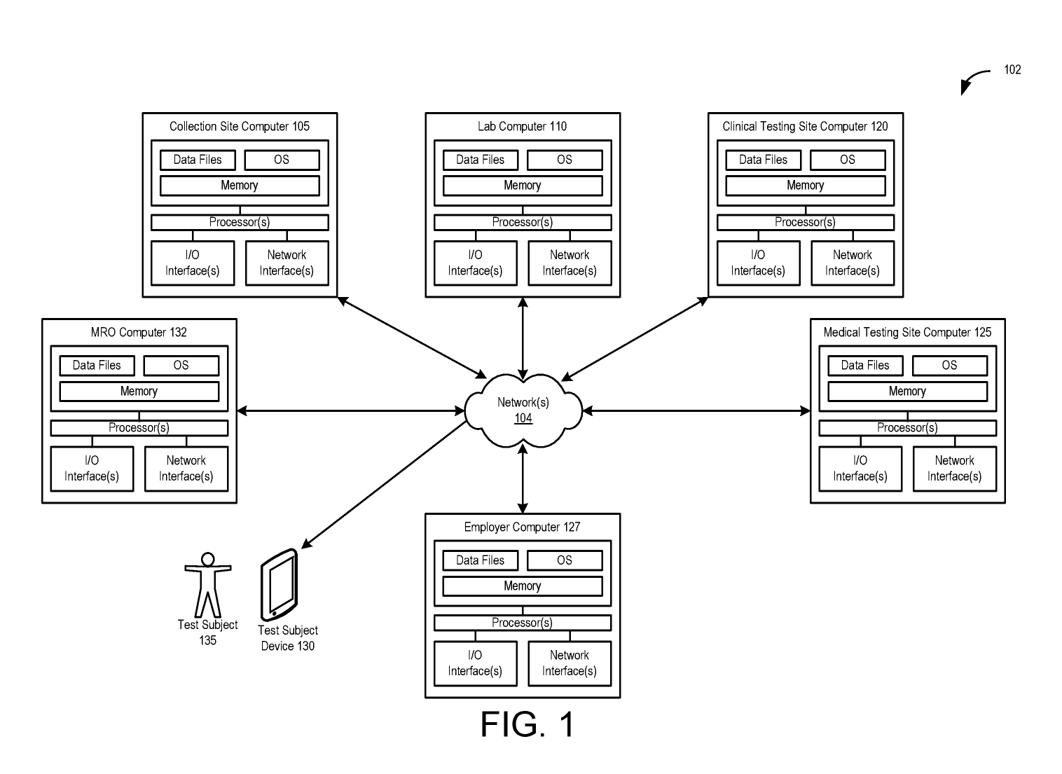

Disclosed herein are systems, devices, and methods that are directed generally to coordinating the administration of test subject screening for various tests, for example, drug tests, clinical tests, and/or medical tests by a screening computing system. FIG. 1 shows an example diagram of a screening computing system 102 for test subjects 135 according to one example embodiment of the disclosure. In one example, the screening computing system 102 can include one or more of a collection site computer 105, a lab computer 110, clinical testing site computer 120, medical testing site computer 125, a medical review office (MRO) computer 132, an employer computer 127, and a test subject device 130 that the screening computing system 102 manages. In various embodiments, the screening computing system 102 can be communicatively coupled via the network 104 and one or more computers at the various sites (for example, the collection site, a lab, clinical testing site, medical testing site, a medical review office (MRO), an employer site) and test subject device(s) 130, for example, a cell phone associated with a test subject 135, or a computer associated with a site, for example, a collection site.

In one example embodiment, the collection site computer 105, the lab computer 110, the clinical testing site computer 120, the medical testing site computer 125, the medical review office (MRO) computer 132, the employer computer 127, and the test subject device 130 may include one or more processors that may be configured for accessing and reading associated computer-readable media having stored data thereon and/or computer-executable instructions for implementing various embodiments of the disclosure.

Generally, network devices and systems, including the screening computing system 102, the collection site computer 105, the lab computer 110, clinical testing site computer 120, the medical testing site computer 125, the medical review office (MRO) computer 132, the employer computer 127, and the test subject device 130, may include or otherwise be associated with suitable hardware and/or software for transmitting and receiving data and/or computer-executable instructions over one or more communication links or networks, for example, network(s) 104. These network devices and systems may also include any number of processors for processing data and executing computer-executable instructions, as well as other internal and peripheral components currently known in the art or which may be developed in the future. Further, these network devices and systems may include or be in communication with any number of suitable memory devices operable to store data and/or computer-executable instructions. By executing computer-executable instructions, each of the network devices may form a special-purpose computer or particular machine. As used herein, the term “computer-readable medium” describes any medium for storing computer-executable instructions.

As shown in FIG. 1, the collection site computer 105, the lab computer 110, the clinical testing site computer 120, the medical testing site computer 125, the medical review office (MRO) computer 132, the employer computer 127, and the test subject device 130 may be in communication with each other via one or more networks, such as network 104, which may include one or more independent and/or shared private and/or public networks including the Internet or a publicly switched telephone network. In other example embodiments, one or more components of the screening computing system 102 may communicate via direct connections and/or communication links. These components—the collection site computer 105, the lab computer 110, the clinical testing site computer 120, the medical testing site computer 125, the medical review office (MRO) computer 132, the employer computer 127, and the test subject device 130—will now be discussed collectively in further detail. Although the components are generally discussed as singular components, as may be implemented in various example embodiments, in alternative exemplary embodiments, each component may include any number of suitable computers and/or other components.

With continued reference to FIG. 1, the collection site computer 105, the lab computer 110, the clinical testing site computer 120, the medical testing site computer 125, the medical review office (MRO) computer 132, the employer computer 127, and the test subject device 130 may include a computing device that includes any number of server computers, mainframe computers, networked computers, desktop computers, personal computers, mobile devices, smartphones, digital assistants, personal digital assistants, tablet devices, Internet appliances, application-specific integrated circuits, microcontrollers, minicomputers, and/or any other processor-based devices. The collection site computer 105, the lab computer 110, the clinical testing site computer 120, the medical testing site computer 125, the medical review office (MRO) computer 132, the employer computer 127, and the test subject device 130 having computer-executable instructions stored thereon each form a special-purpose computer or other particular machine that is operable to facilitate the processing of transactions/requests for information made by or on behalf of the various sites and the communication of requested information as described in the example embodiments herein. Additionally, in certain embodiments, the operations and/or control of the collection site computer 105, the lab computer 110, the clinical testing site computer 120, the medical testing site computer 125, the medical review office (MRO) computer 132, the employer computer 127, and the test subject device 130 may be distributed among several processing components. In addition to including one or more processors, the components (for example, the collection site computer 105) may further include one or more memory devices (or memory), one or more input/output (“I/O”) interfaces, and one or more network interfaces. The memory devices may be any suitable memory devices, for example, caches, read-only memory devices, random access memory devices, magnetic storage devices, removable storage devices, etc. The memory devices may store data, executable instructions, and/or various program modules utilized by the collection site computer 105, the lab computer 110, the clinical testing site computer 120, the medical testing site computer 125, the medical review office (MRO) computer 132, the employer computer 127, and the test subject device 130, for example, data files, and an operating system (“OS”).

The OS may be a suitable software module that controls the general operation of the collection site computer 105, the lab computer 110, the clinical testing site computer 120, the medical testing site computer 125, the medical review office (MRO) computer 132, the employer computer 127, and the test subject device 130. The OS may also facilitate the execution of other software modules by the one or more processors. The OS may be any operating system known in the art or which may be developed in the future including, but not limited to, Microsoft Windows®, Apple OSX™, Apple iOS™, Google Android™, Linux, Unix, or a mainframe operating system.

The one or more I/O interfaces may facilitate communication between the collection site computer 105, the lab computer 110, the clinical testing site computer 120, the medical testing site computer 125, the medical review office (MRO) computer 132, the employer computer 127, and the test subject device 130 and one or more input/output devices, for example, one or more user interface devices, such as a display, keypad, control panel, touch screen display, remote control, microphone, etc., that facilitate user interaction with the collection site computer 105, the lab computer 110, the clinical testing site computer 120, the medical testing site computer 125, the medical review office (MRO) computer 132, the employer computer 127, and the test subject device 130. For example, the one or more I/O interfaces may facilitate entry of information associated with a testing request by a healthcare provider, such as a physician. The one or more network interfaces may facilitate connection of the collection site computer 105, the lab computer 110, the clinical testing site computer 120, the medical testing site computer 125, the medical review office (MRO) computer 132, the employer computer 127, and the test subject device 130 to one or more suitable networks, for example, the network 104 illustrated in FIG. 1. In this regard, the collection site computer 105, the lab computer 110, the clinical testing site computer 120, the medical testing site computer 125, the medical review office (MRO) computer 132, the employer computer 127, and the test subject device 130 may receive and/or communicate information to other network components of the screening computing system 102.

Those of ordinary skill in the art will appreciate that the screening testing system 102 shown in and described with respect to FIG. 1 is provided by way of example only. Numerous other operating environments, system architectures, and device and network configurations are possible. Other system embodiments can include fewer or greater numbers of components and may incorporate some or all of the functionality described with respect to the system components shown in FIG. 1. For example, in an exemplary embodiment, the MRO computer 132 (or another computer) may be implemented as a specialized processing machine that includes hardware and/or software for performing the methods described herein. Accordingly, embodiments of the disclosure should not be construed as being limited to any particular operating environment, system architecture, or device or network configuration.

In one example embodiment, the MRO computer 132 can include an embeddable software module that the employer can include in a website and/or software application (for example, Oracle software) associated with the employer, for example, at an employer computer. In one example embodiment, the MRO computer 132 can receive requests for one or more tests (for example, a drug test, a physical test, and a cholesterol test, among other possible tests) for a test subject (alternatively referred to herein as an test subject, a patient, a user, and/or a job applicant) from an employer computer 127. In one example embodiment, the MRO computer 132 can receive a selection of one or more tests for a group of test subjects sharing a particular characteristic (for example, test subjects having a given age, expertise, and the like), for the which the test subject may be a member of the group.

The MRO computer 132 can determine, based at least in part on the requested tests, one or more sites (for example, clinical sites, collection sites, and/or medical sites) that can perform the requested tests. The determination of the sites can be based at least in part on, the type of test being requested, whether multiple tests can be completed at a single site, the cost of a site change for test(s) requested, a physical location of the site, the physical location of the test subject 135, and/or the physical location of the employer. In another embodiment, the determination can be based at least in part on receiving an input from the test subject device 130, for example, a location preference provided by the test subject. In another embodiment, the determination can be based at least in part on receiving an employer input from the employer computer 127, for example, an employer location preference for conducting the needed tests. The MRO computer 132 may determine the one or more sites that satisfy the particular parameters and generate a display of the sites that can perform the requested tests. The MRO computer 132 can then transmit the generated display to the test subject device 130 and/or employer computer 127 for display on the test subject device 130 and/or the employer computer 127 in list form and/or on a map having markings to indicate the testing locations to the test subject, employer, and any other user.

In various embodiments, the MRO computer 132 can receive information from a test subject 135. In one example the information from the test subject can include, but is not limited to, a user's (test subject's) name, address, date of birth, social security number, and the like. The MRO computer 132 may use this information in registering or pre-registering the test subject 135 for the one or more tests at the one or more testing sites. In one example embodiment, the MRO computer 132 may schedule the test (for example, a medical test) based on an availability of a site, a test subject's schedule, and/or an employer's schedule (for example, a deadline to complete the testing and receive results). The MRO computer 132 may receive an identifier, for example, an alphanumeric code, barcode, or QR code, from the testing site computer to indicate that the test subject 135 has been registered or pre-registered for the test. The MRO computer 132 can send the received code to the test subject device 130 so that the test subject 135 may present a display of the received code to the particular test site computer prior to testing. Alternatively or additionally, the MRO computer 132 can send the registration or pre-registered information via a pass on an Apple Passbook to the test subject device 130 of the test subject 135.

In various example embodiments, the MRO computer 132 can generate forms related to the scheduling, administration, and/or legal requirements associated with the tests. In one example embodiment, the forms can be sent to a test subject device 130 associated with the test subject 135 for completion. For example, the forms may include a drug screening form that has various fields to be filled out by the test subject 135. In one example embodiment, the forms may include a bar code for identification of the requested test. In another example, the forms may include a medical and/or clinical form for completion and printing by the test subject 135 using a test subject device 130. In one example embodiment, the completed forms may be stored at the MRO computer 132 or a software module associated with the MRO computer 132, for example, in a Passbook app module associated with the MRO computer 132.

In one example embodiment, the MRO computer 132 can receive status information from the particular testing site computer, for example, from a collection site computer 105, a medical and/or clinical lab computer 110, and/or a medical testing site computer 125 at any point in the process, for example, before, during, and after the period the test subject 135 goes for the test.

In one example embodiment, the particular site associated with each of the collection site computer 105, the lab computer 110, the clinical testing site computer 120, and the medical testing site computer 125 can include a lab site. The lab site can include anatomic pathology labs that can include, but is not be limited to histopathology labs, cytopathology labs, and electron microscopy labs. The lab site can include a clinical pathology lab. The clinical pathology lab can further include a clinical microbiology lab. The clinical microbiology lab can include a bacteriology lab, virology lab, parasitology lab, immunology lab, and mycology lab. The lab site can include a clinical chemistry lab, which can perform instrumental analysis of blood components, enzymology, toxicology and endocrinology. The lab site can include a hematology lab for the automated and manual analysis of blood cells. The lab site can include a genetics and/or cytogenetics lab. In one example embodiment, the lab site can include a reproductive biology lab including semen analysis.

In various example embodiments, the computer test sites of the sites (e.g., the clinical testing site(s) computer 120, lab site(s) computer 110, medical testing site(s) computer 125, collection site(s) computer 105, and the like) can send and receive information, for example, status information, to and from the MRO computer 132. In one example embodiment, the status information can be provided at least in part by the staff of the sites manually inputting the status information into the respective computers at the particular site. The staff of the sites may include: a pathologist, a clinical biochemist, a pathologists' assistant (PA), a biomedical scientist (BMS), a medical laboratory scientist (MLS), a medical laboratory technologist, a medical laboratory technician (MLT), a medical laboratory assistant (MLA), and a phlebotomist (PBT), and a data entry operator, among other users.

In one example embodiment, the various site computers (e.g., the clinical testing site(s) computer 120, lab site(s) computer 110, medical review office(s) computer 132, medical testing site(s) computer 125, collection site(s) computer 105, and the like) can exchange data (for example, status updates related to a test subject 135, scheduling information, and other information) with the MRO computer 132 and/or with other site computers of the screening computing system 102 (e.g., the clinical testing site(s) computer 120, lab site(s) computer 110, medical testing site(s) computer 125, collection site(s) computer 105, and the like), and with employer computers 127 and/or test subject device(s) 130.

In various embodiments, a drug test can refer to a technical analysis of a biological specimen, for example urine, hair, blood, breath, sweat, or oral fluid/saliva, in order to determine the presence or absence of specified parent drugs or their metabolites. For example, the technical analysis can comprise an immunoassay test. The test can, for example, ascertain the presence of the following metabolites: marijuana metabolites, cocaine metabolites, opiate metabolites, phencyclidine, amphetamines, and other examples. In one example embodiment, medical tests can include, but are not limited to, a physical, a stress test, immunization tests, and the like. In one example embodiment, clinical tests can include, but are not limited to, an immunization test, a cardio-check test, thyroid test, life expectancy test, cholesterol/HDL index test, and a body mass index test.

In various embodiments, the site computers (for example, the collection site computer(s) 105, lab site computer(s) 110, clinical testing site computer(s) 120, medical testing site computer(s) 125, medical review office computer(s) 132, and the like) and/or the MRO computer 132 can produce legal forms for compliance with various local, state, and/or federal laws. For example, the medical testing site computers 125 may generate a form in order to comply with local and/or federal laws. The forms produced by the site computers can, in one example embodiment, be stored at a server (not shown) associated with the MRO computer 132 and/or locally on the test subject device 130, in connection with or independent from the MRO computer 132.

In one example embodiment, the MRO computer 132 can generate, customize and manage forms, for example, medical forms. The MRO computer 132 can receive information of the test subject 135 from the employer computer 127 and/or the test subject device 130 and receive a selection of a medical procedure for the test subject 135. The MRO computer 132 can then identify, based at least in part on the tests requested, one or more individual medical forms which are required to support the medical test. The MRO computer 132 can generate the forms such that the generated forms are automatically populated with at least the received test subject information (for example, a name, an address, a phone number, a social security number, a health insurance claim number, and the like for the test subject 135) received from the test subject device 130 and/or the employer computer 127 and any received information from the employer computer 127.

In one example embodiment, a client/server infrastructure or a cloud based infrastructure (not shown) may be implemented to provide one or more local and remote clients (for example, testing site computers, employers, etc.) access to the form generation and customization according to the disclosed embodiments.

In one example embodiment, the MRO computer 132 can allow individual medical providers who have licensed or otherwise obtained authorization to access the generated forms. As such, the MRO computer 132 may serve as a central repository of individual medical form data which may be accessed by licensed medical providers using the MRO computer 132 in connection with, for example, a global area network (not shown), including a cloud-based computing based system. In such an arrangement, authorized users may access the MRO computer 132 using a computer having only a browser and network capability. Unauthorized access to the MRO computer 132 may be prevented by implementing known network security infrastructures and protocols, such as a virtual private network (VPN), firewalls, access lists and the like.

In one example embodiment, the MRO computer 132 can track the collection of specimens from the test subject 135 by the one or more testing sites (e.g., the collection site associated with the collection site computer 105, the lab associated with the lab computer 110, the clinical testing site associated with the clinical testing site computer 120 and/or the medical testing site associated with the medical testing site computer 125). For example, the collection site can acquire various specimens from the test subject 135, including, but not limited to, a urine specimen, a stool specimen, a blood specimen, a hair specimen, a serum specimen, a semen specimen, and the like.

In one example embodiment, the MRO computer 132 can receive notifications from the collection site computer 105 providing a status update of the administration of various tests or collections by the collection site, for example, an Enzyme Multiple Immunoassay Test (EMIT), a Gas Chromatography Mass Spectrometer (GC MS), a Saliva Drug Testing (Oral Fluid), Blood Drug Testing, and/or a Hair Follicle Testing.

In various embodiments, status information can include an indication that the test subject 135 has checked into the collection site associated with collection site computer 105 (e.g., the computer is located within or under the control of the collection site). The status information can include an indication that a specimen has been retrieved from the test subject 135. The status information can include an indication that the test subject 135 or the collection site has begun the testing. The status information can include an indication that the test subject 135 has passed or failed the testing and/or the results of the testing. The status information can include an indication that there has been some irregularity associated with the testing. The status information can include an indication that the site, for example, the clinical and/or medical site, needs further information from the test subject 135 and/or the employer, for example, prior to proceeding with or completing the test. For example, the site may require a social security number associated with the test subject 135 prior to proceeding with the test.

In one example embodiment, the MRO computer 132 can receive the result of the test from a site computer (e.g., the collection site computer 105, the lab computer 110, the clinical testing site computer 120 and/or the medical testing site computer 125). This can be, for example, in the form of a Portable Document Format (PDF) file, an XML file, a webservice, or any other kind of electronic file and/or communication from the particular site computer.

In one example embodiment, the MRO computer 132 can transmit the results of the test to one or more entities, for example, the employer computer 127 and/or the test subject device 130, in accordance with one or more rules, for example, one or more business rules. In another embodiment, the MRO computer 132 can send positive results to a medical review office computer 132 for further review by a licensed physician, for review prior to sending the result of the test to the test subject 135 and/or the employer computer 127. If the MRO computer 132 receives an indication from the medical review computer 132 that the physician determined that the test is invalid or that further testing needs to be performed, the MRO computer 132 may not send the results to the employer via the employer computer 127. The MRO computer 132 may instead transmit to the employer computer 127 and/or the test subject device 130, via an electronic communication, information indicating that the test was invalid, that the test needs to be redone, and/or that further testing needs to be performed. For example, the MRO computer 132 can transmit the results of the test via the network 104 to an employer computer 127 associated with the employer (e.g., located within or under the control of the employer), but not report the results of the test to the test subject 135 via the test subject device 130. In another embodiment, the MRO computer 132 can report the results of the test via the network 104 to a third party entity, for example, a recruiting firm that does not reveal the details of the results of the test to the employer and/or the test subject 135, but rather provides a binary pass or fail result to the employer at the employer computer 127 and/or the test subject 135 at the test subject device 130 based on a predetermined criteria. The predetermined criteria may be, for example, one or more parameter(s) associated with the test(s) exceeding a threshold.

In one example embodiment, the MRO computer 132 can receive a time frame range or threshold and a reason for a medical appointment scheduling information from a test subject device 130 associated with the test subject 135 and/or an employer computer 127 associated with the employer. Based on the information received, the MRO computer 132 can determine a requested medical, clinical, drug-testing, and/or other type of service and/or test associated with one or more particular collection or testing sites, can identify resources required for the service, can determine one or more sites that complete the testing, and can generate a schedule of options and transmit the schedule of options to the employer computer 127 and/or test subject device 130 based on the identified tests and/or resources of the particular testing and/or collection sites. The MRO computer 132 can schedule a time frame with the particular collection or testing site computer(s) on behalf of the test subject 135 and/or employer associated with the employer computer 127 based on the reason for the appointment. The resources scheduled can include a medical practitioner, and can also be a geographic office location, medical equipment, laboratory time, or other resource necessary for a selected service. After schedule options are provided to the test subject device 130 and/or employer computer 127, the MRO computer 132 can accept an input from the test subject device 130 (e.g., by the test subject 135) and/or employer computer 127 to select an appointment from the schedule options, and transmit, via the network 104, the appointment data to a schedule for the particular collection and/or testing site computer(s) to schedule an appointment. As described below, when scheduling an appointment, the MRO computer 132 can automatically transmit to the test subject device 130 and/or employer computer 127 targeted questionnaires and necessary information for the appointment (for example, using the one or more generated forms) to assure that both the test subject 135 and the particular collection and/or testing site computer have necessary information before the test subject's appointment.

In one example embodiment, the MRO computer 132 can provide and apply verifiable digital signatures to electronic documents and images from desktop, mobile or network-connected devices, for example, various documents in connection with the administration and/or reporting and registration of the various tests by the particular collection and/or testing sites. The MRO computer 132 can use a document viewer and apply digital signatures to these documents, and finally authenticate signing parties using multi-factor authentication and verification of the signer's credentials from a central, public Certificate Authority (e.g., an ISO 32000 compliant PDF viewer). In one example embodiment, documents that require signing can be stored on a document management server (not shown) communicably coupled to and associated with the MRO computer 132, and details of how documents should be processed for signing can be managed by a workflow manager process, which can capture details such as documents to be signed, signing locations, signing parties, due dates, notifications, and required metadata.

In one example embodiment, the MRO computer 132 can determine and/or receive a range of schedule times or a range of geographic locations acceptable for the appointment to receive the testing, and can generate a display of the schedule options for resources available within the range of schedule times or geographic locations and can transmit the generated display for presentment via the network 104 on the test subject device 130 and/or employer computer 127. The MRO computer 132 can also determine appointment lengths for different types of collection and/or testing service appointments by, for example, communicating with a database providing data indicating appointment lengths for different types of service appointments, and generate a schedule of options which accommodate an appointment of the required length. The generated schedule options presented can also be filtered to indicate only those collection and/or testing sites and resources that can provide the test.

In another example embodiment, the MRO computer 132 can generate and transmit a reminder or alert notification about an upcoming collection and/or test appointment via the network 104 to the test subject device 130 and/or employer computer 127. In certain example embodiments, the alerts can be generated and transmitted at either predetermined intervals or at a time selected by the test subject 135 and/or employer associated with the employer computer 127 through a setting provided on the MRO computer 132. The MRO computer 132 can also receive from the test subject device 130 and/or employer computer 127 a request to cancel an appointment. The MRO computer 132 can transmit a cancellation request and any cancellation data to the particular collection and/or test site(s) in response to receipt of the cancellation request.

In still another example embodiment, the MRO computer 132 can include or otherwise be communicably coupled to a database (not shown) that includes operating and/or appointment schedules for one or more of the collection and/or testing sites. The MRO computer 132 can accesses the database, based at least on the types of tests requested and one or more location parameters to identify test sites capable of completing the one or more of the tests requested and to identify resources required for the test(s) requested, to identify openings/availability in the schedules of the test sites capable of completing the one or more requested tests, and generating a schedule of appointment options according to common schedule openings of the collection and/or testing sites and the test subject 135. The common schedule openings can also be generated based on the test sites being within a predetermined geographic range of the address of the test subject 135 or employer associated with the employer computer. In one example embodiment, the predetermined geographic range is anywhere between approximately 0.1-100 miles and preferably between approximately 0.1-40 miles.

In yet another example embodiment, the MRO computer 132 can receive requests for testing requiring multiple sequential steps for the test subject 135 and can further accommodate the scheduling of the testing requiring multiple sequential steps for the test subject 135. The MRO computer 132 can, based at least in part on the type of test requested (e.g., a test name or test type code), identify testing sites and resources needed for each step of the requested test, determine different combinations of the multiple testing sites and resources that can be used to accomplish completion of the requested test, determine schedule availability at one or more of those multiple testing sites, generate a listing of the different combinations of multiple testing sites for scheduling, and transmit the generated listing to the test subject device 130 and/or the employer computer 127. For example, in a multi-step process, the first step can require a laboratory test and the MRO computer 132 communicates with a lab computer 110 providing data indicating laboratory test processing delay, and the MRO computer 132 can determine the steps appropriately to accommodate the required delay. The MRO computer 132 can also receive from the one or more collection and/or testing site computers, test subject device 130, and/or network 104 information indicating travel time delays between the geographic locations of the test sites and/or the test subject 135 and the test sites and can determine and generate a listing of schedule options which accommodate the travel time delay. The MRO computer 132 can also store the series of steps together in a log or other data structure such that, if a cancellation request is received, one or more steps for the procedure are cancelled.

In various example embodiments, the MRO computer 132 can determine one or more testing sites to complete the requested test(s) based on geographical proximity of the test subject 135 and/or employer associated with the employer computer 127 to the test sites. The determination can be based on, for example, an address for the test subject 135 and/or employer, a global positioning location provided by a test subject device 130 associated with the test subject 135, and/or an address provided by an employer of the test subject 135. The MRO computer 132 can, after determining the test sites within the geographical proximity, generate the list of the test sites within the geographical proximity and transmit the generated list of test sites to the test subject device 130 and/or employer computer 127 in a list format, for example, through an app on the test subject device 130 or on the employer computer 127. The list may, in various example embodiments, be arranged in order of increasing or decreasing distance to the test subject 135 and/or employer associated with the employer computer 127 based at least in part on the location information associated with the test subject device 130, the test subject 135, and/or the employer. The test subject 135 and/or employer associated with the employer computer 127 can optionally chose one testing site from among the one or more sites provided based on location and the MRO computer 132 can receive the selection of the one testing site from the test subject device 130 or employer computer 127 via the network 104.

Alternatively or additionally, the MRO computer 132 can determine one or more test sites based on a cost associated with the services provided by each particular test site for the test or collection requested. For example, the MRO computer 132, can determine an employer identifier identifying the employer in the received test request from the employer computer 127 associated with that employer or the test subject device 130. In certain example embodiments, the employer identifier can be one or more of the name of the employer, the address of the employer, an alphanumeric code assigned to uniquely identify the employer, and the like. The MRO computer 132 can compare the received employer identifier to a schedule of employer identifiers in, for example, a database or other memory available to the MRO computer 132 to identify a matching record that includes the same employer identifier. The matching record can include one or more rules for identifying and scheduling testing sites for test requests for the employer associated with the employer computer 127. These rules can include an indicator to schedule the testing of the test subject 135 with a testing site having the lowest cost within a particular geographic area. The MRO computer 132 can determine, based on the type of test requested one or more testing sites within the predetermine geographic range or threshold distance of the employer or test subject 135 that can complete the test on the test subject 135 within the predetermined amount of time and/or before a threshold completion date. After determining the one or more testing sites, the MRO computer 132 can identify the test site or combination of test sites that can complete the one or more requested tests on the test subject 135 at the lowest cost. The MRO computer 132 can generate a listing and/or map identifying the testing site and/or the location of the testing site. In another example embodiment, the MRO computer 132 can generate a display of the list of the testing sites, arranged in order of cost, and can transmit that display of the list of testing sites to the test subject device 130 and/or employer computer 127 in a list format, for example, through an app on the test subject device 130 or the employer's computer 127. The list may, in various example embodiments, be arranged in order to increasing or decreasing cost. The test subject 135 and/or employer can optionally chose one site from among the one or more sites provided and the selection can be transmitted to and received by the MRO computer 132.

In one example embodiment, the employer can integrate a user interface module (not shown) provided by the MRO computer 132 in a website, mobile site, and/or other software application for the employer computer 127. The user interface module can be used to integrate seamlessly with the employers pre-existing website, mobile site, and/or other software application. The employer can then have the test subject 135 enter information, for example, the test subject's personal information, into the embedded user interface module.

In various example embodiments, the MRO computer 132 can integrate with an Apple Wallet (alternatively referred to herein as Wallet and/or Passbook). Apple Wallet can refer to an application in Apple's iOS (previously known as Passbook in iOS 6 to iOS 8) that can allow a test subject 135 via the test subject device 130 to download and store appointment times for testing at test sites scheduled by the MRO computer 132.

In one embodiment, the various site computers (e.g., the clinical testing site(s) computer 120, lab site(s) computer 110, medical review office(s) computer 132, medical testing site(s) computer 125, collection site(s) computer 105, and the like) can store at least partial instructions (for example, in the form of software instructions) that allow the various site computers to perform the operations disclosed herein. In one embodiment, these instructions (for example, in the form of software instructions) can be updated (for example, in the form of software updates and/or upgrades) simultaneously or nearly simultaneously on the various site computers, or individually, on one or more of the various site computers. In one embodiment, the updates can include, but are not be limited to, instructions to facilitate synchronization, information exchange, authentication, and the like among the various site computers.

In one embodiment, the MRO computer 132 of the MRO computer 132 can include a master copy of any software and/or operational instructions that can coordinate the operations among one or more of the various site computers (e.g., the clinical testing site(s) computer 120, lab site(s) computer 110, MRO computer 132, medical testing site(s) computer 125, collection site(s) computer 105, and the like). In one embodiment, the MRO computer 132 can include a server that can provide functionality for one or more of the various site computers, which can be referred to as clients in such a scenario. The MRO computer 132 can communicate with one or more of the various site computers (e.g., the clinical testing site(s) computer 120, lab site(s) computer 110, medical testing site(s) computer 125, collection site(s) computer 105, and the like) based on the master copy of the software running on the MRO computer 132.

In one example, the location (for example, a global positioning system (GPS) location) of a test subject device 130 and/or a test subject 135 can be determined by the MRO computer 132 (or one or more of the various site computers, e.g., the clinical testing site(s) computer 120, lab site(s) computer 110, medical review office(s) computer 132, medical testing site(s) computer 125, collection site(s) computer 105, and the like) or received by the MRO computer 132 from the test subject device 130.

In another example, this determination of the location of the test subject device 130 and/or a test subject 135 by the MRO computer 132 (or one or more of the various site computers) can be performed by sending instructions to the test subject device 130 specifying the location of one or more predetermined site location(s) (for example, a collection site location, a clinic location, a medical testing site location, a lab location, an employer location, and/or any other suitable location). Further, the MRO computer 132 (or one or more of the various site computers) can send instructions to the test subject device 130 (or the test subject device 130 can be configured) to send an update that the device 130 is within a given threshold distance to the predetermined site location(s) (for example, the collection site location, the clinic location, the medical testing site location, the lab location, the employer location, and/or any other suitable location). Accordingly, the MRO computer 132 (or one or more of the various site computers) can determine the location of the test subject 135 based on the information received from the test subject device 130.

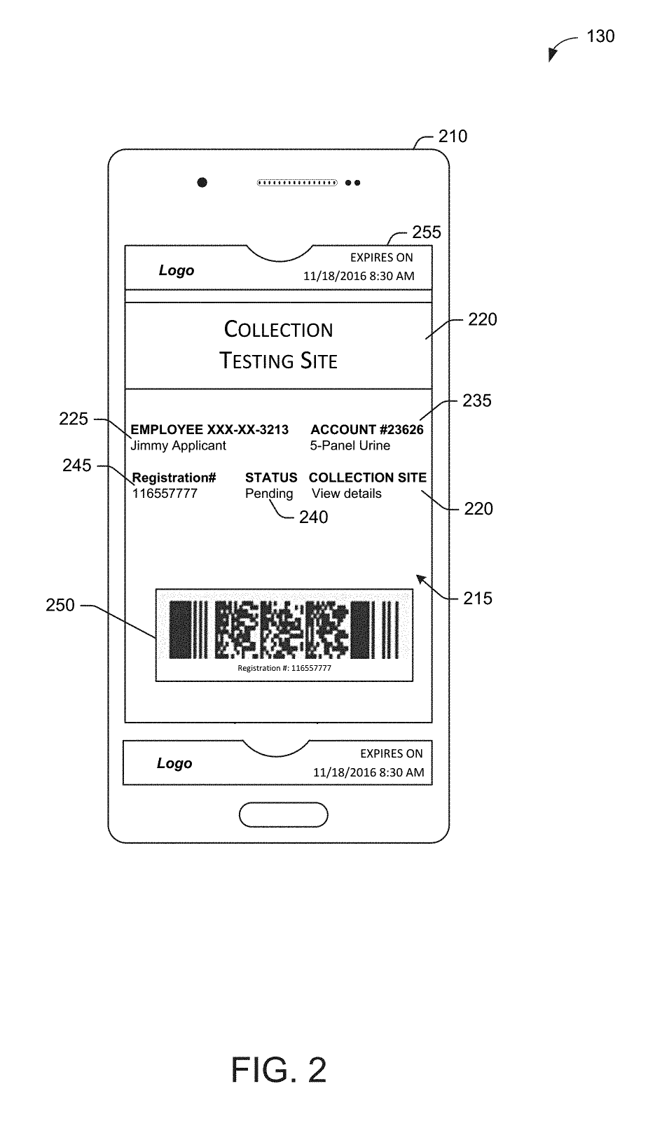

FIG. 2 shows a diagram of one example of a test subject device 130 showing a user interface screen 215 generated by the MRO computer 132 and transmitted to the test subject device 130 via the network 104. Referring now to FIGS. 1 and 2, the user interface screen 215 can include a pass for the test subject 135 to show to a testing site, for example, a collection site associated with a collection site computer 105 to have a test or collection conducted. The name 220 of the testing site can be displayed on the user interface screen 215. Additionally, identifying information identifying the test subject 135 can be displayed. The identifying information can include a test subject name 225, at least 4 digits of a social security code, health insurance claim number, or other test subject identifier 230 associated with the test subject 135, a test 235 to be performed on the test subject 135, a current status 240 for the test to be performed on the test subject 135, a registration number 245 or other appointment identifier associated with or otherwise identifying the appointment generated by the MRO computer 132. Moreover, the user interface screen 215 can include a code 250, for example, an alphanumeric code, bar code 250, QR code, or any other form of 2-dimensional code associated with or otherwise identifying the appointment generated by the MRO computer 132 for the test subject 135. Furthermore, the user interface screen 215 can include a time stamp 255 or time threshold indicating an expiration date and time for the test to be performed and/or completed for the test subject 135.

Returning to FIG. 1, in one example embodiment, the MRO computer 132 can configure the test subject device 130, including a Wallet application on the test subject device 130 to display Aztec, PDF417 and QR 2D barcodes and Code 128 1D barcodes. Each digital coupon or ticket can be referred to as a “pass.” The pass can be presented to the staff of the testing site(s) by the test subject 135 when the test subject 135 goes for the administration of the one or more tests. Passes can also be distributed online via Safari, sent to the test subject 135 via email, or scanned using the built-in scanner in the Wallet app. Passes can be synced between iOS devices using iCloud, and OS X 10.8.2 and higher also support opening passes to be sent to test subjects' iOS devices.

The MRO computer 132 can configure the test subject device 130, including the Wallet application on the test subject device 130, to displays 2D barcodes of at least the following types: Aztec, PDF417 and QR. The MRO computer 132 can configure the test subject device 130, including the Wallet application on the test subject device 130, to furthermore display 1D barcodes of at least the following types: Code 128 beginning with iOS 9. In various example aspects, the MRO computer 132 can configure the test subject device 130, including the Wallet application on the test subject device 130, to be triggered by location, for example, test subject proximity to a predetermined testing site.

In one example embodiment, the MRO computer 132 can be configured to add a predetermined number of locations, for example, ten locations, to each pass. Each location can correspond to a testing site that the test subject 135 can visit for the administration of the requested test(s). A location can be programmed as GPS coordinates (longitude, latitude, and altitude) and/or iBeacon UUID (The UUID is a Universally Unique Identifier which is a 32 ASCII character code or a code automatically generated from a name using the PassKit API). The location can be programed by the MRO computer 132 including the Wallet application. In one example embodiment, the pass changes can be pushed via the Apple Push Notification Service by the pass provider, or manually updated by the test subject 135 and/or employer associated with the employer computer 127 themselves. In another example embodiment, the passes can be distributed via email, SMS, MMS, the web, social media, an app, and as QR codes.

In one example embodiment, the MRO computer 132 can be configured to use the passbook to generate and insert predetermined reminders to a test subject 135, a testing site associated with one or more of the site computers, and/or employer associated with the employer computer 127, for example, reminders approximately 24 hours before a scheduled appointment time for a test, or approximately 72 hours prior to the scheduled appointment time for a test. The reminders can be generated based on input received from a test subject device 130 for a test subject 135 and/or input received from an employer computer 127 for an employee at the MRO computer 132, for example, a preference regarding the amount of time before an appointment with a site to have the reminder.

In one example embodiment, the MRO computer 132 can automatically load the passbook on a test subject device 130, for example, on a smartphone lock screen, when the test subject 135 is within a predetermined distance of a testing site, for example, when the test subject 135 is within approximately 1 mile of a collection site associated with the collection site computer 105 or any other testing site.

In one example embodiment, the MRO computer 132 can update the passbook to show a status associated with the appointment for the test for the test subject 135. For example, the passbook can show a corresponding status once collection of a test specimen from the test subject 135 at a collection site is completed. Alternatively, it can show an expired status if a deadline or threshold completion date for the requested test associated with the appointment passes and is not completed in the necessary time.

In one example embodiment, the MRO computer 132 can be configured to integrate the passbook with a background check software, an HR software, or an applicant tracking system (ATS) software.

In one example embodiment, the MRO computer 132 can track a test subject 135 and the requested tests for that test subject 135 through the MRO computer 132 or through any other method. For example, the MRO computer 132 can track the test subject's progress through a collection site associated with the collection site computer 105. This can include registration and/or check-in, sample collection (for example, urine collection), sample testing, and results. In one example aspect, the tracking of the status of the requested tests for the test subject 135 can be used to determine whether the process and/or requested test malfunctioned at any point in the workflow. This can be a result, for example, of an error by the testing site (for example, the collection site, clinical testing site, and/or medical testing site), or may be the result of a test subject 135 not following the regulations and/or protocol of the test accordingly.

For example, the MRO computer 132 can receive status updates from the one or more testing site computers via the network 104 before, during, and after a testing or collection process at one or more of the collection and/or testing sites and can store those status updates in a record associated with the test subject 135. Further, the MRO computer 132 can determine, for example based on the employer identifier in the test request, if the status update should be transmitted to the employer computer 127 via the network 104. For example, the MRO computer 132 can compare the employer identifier from the test request to a schedule of employer identifiers in, for example, a database or other memory to identify a matching record that includes the same employer identifier. The matching record can include one or more rules for transmitting status updates (e.g., if status updates are transmitted, which status updates are grouped before transmitting, which types of status updates are transmitted) on testing to an employer computer 127 and/or other entity regarding the specimen collection process. Based on those rules, the MRO computer 132 can determine and if the rule is satisfied, transmit the status update to the employer computer 127 and/or entity. The MRO computer 132 may transmit a first status update to the employer computer 127 upon the completion and/or shipping of the chain of custody form and/or specimen. The MRO computer 132 may transmit a status update to the employer computer 127 reporting a client altering or substituting a specimen. For example, the MRO computer 132 may transmit a report to the employer computer 127 that the urine specimen is outside the normal temperature range (32.5° C., 90.5°-99.8° F.) and the test subject 135 will not allow an oral body temperature to be taken, and/or the oral body temperature is 1° C./1.8° F. different from the temperature of the specimen. The MRO computer 132 may transmit to the employer computer 127 a status update reporting that the collection site person observed behavior that clearly indicates an attempt to alter or substitute a specimen or otherwise circumvent the test procedure. The MRO computer 132 may transmit a status update to the employer computer 127 reporting a “split sample” of the biospecimens, for example, urine, is collected. In the split sample method the biospecimen, for example, a urine specimen, is divided into two containers.

The MRO computer 132 may transmit a status update to an employer computer 127 reporting a failure on the part of the test subject 135 to provide an adequate amount of a biospecimen, for example, at least 45 ml (milliliters) of urine. In one example embodiment, the MRO computer 132 may transmit a status update to the employer computer 127 that the test subject 135 was unable to provide the minimum amount of urine, and/or that the collection site is having the client drink up to 24 ounces of fluid and try to provide a sample within two hours. In one example embodiment, the MRO computer 132 may transmit a status update to the employer computer 127 that the test subject 135 is still unable to provide a complete sample, and that the test is stopped.

In one example embodiment, the results of the test can be transmitted via the network 104 to the employer computers 127 associated with the one or more employers requesting the test through the MRO computer 132. The communication can be in the form of a XML delivery, a webservice, a PDF file, and the like. In another example embodiment, the results can be transmitted to the test subject 135, for example, by transmitting them to the test subject device 130. The results can be electronically transmitted to the test subject device 130 if the local laws permit. In one example embodiment, the results can be transmitted to the test subject device 130 only if the employer has previously agreed, for example, if the employer computer 127 transmits and the MRO computer 132 receives a notification that the employer associated with the employer computer 127 allows the test subject 135 to receive the results of the test.

In one example embodiment, the test subject 135 can transmit via the network 104 a notification to the MRO computer 132 that the employer allows the test subject 135 to receive the status indications of the test, for example, through the test subject device 130. In another example embodiment, the test subject 135 can transmit via the test subject device 130 through the network 104 a notification to the MRO computer 132 that the employer allows the candidate to receive only a subset of the status indications of the test, for example, through the test subject device 130.

In one example embodiment, the MRO computer 132 may receive and can facilitate examination and review of all positive drug test results and any other positive, negative, or other types of test results as desired or required under federal, state, or local regulations, to determine if there is an alternative medical explanation for the received test result. Before making a final decision as to whether a test result is valid, a licensed physician associated with the medical review computer can provide the test subject 135 with the opportunity to discuss the test result. If the physician determines there is a legitimate medical explanation for the positive test result, an entry can be made by the physician at the medical review computer the modifies or adds additional information to the test results and/or report and the medical review computer can transmit a report to the employer computer 127 that the test is negative. In one example embodiment, the features and actions of the medical review computer can be incorporated into the MRO computer 132.

The MRO computer 132 can determine (via various authentication procedures) that the medical review computer(s) is associated with an operator that meets one or more of the following requirements: a licensed a medical doctor (MD) or doctor of osteopathic medicine (DO), knowledgeable about substance abuse disorders, plus clinical experience, and/or certified by a nationally recognized MRO certification board. The authentication procedures can include, receiving, by the MRO computer 132, a credential, certificate, a standardized identifier, a signature, and the like, from the medical review computer.

In one example embodiment, the MRO computer 132 can transmit to the medical review computer the test results received from one or more testing site computers (e.g., the collection site computer(s) 105, the lab computer(s) 110, the clinical testing site computer(s) 120 and/or the medical testing site computer(s) 125) so that the physician associated with the medical review computer may review the results to make sure the correct test panel was performed and that the correct procedures were followed by the one or more testing sites. The MRO computer 132 can furthermore receive notes and updated specimen-related information in the record of the test subject 135 from the medical review computer in connection with the test associated with the test results. The MRO computer 132 can also transmit a checklist to the medical review computer to ensure a proper review by the physician associated with the medical review computer of the test results. When a drug test is reported positive by the particular testing site computer, the medical review computer may also contact the test subject 135 (e.g., the job applicant) through the MRO computer 132 and/or the test subject device 130 to determine if there is a legitimate medical explanation for the positive drug test result or other test results under review. For example, some prescription medications or medical treatments can cause a false positive test result. In these cases, the medical review computer can receive verification of a valid prescription or recent medical treatment on the test subject 135 independently, or through the MRO computer 132. The false positive test result or any other test result under review and deemed to be faulty can then be updated, modified or otherwise changed as needed and transmitted to the employer computer 127 through the MRO computer 132 as a negative result or other result because there is a legitimate, verified, medical reason for the false positive test result or other incorrect test result. However, if the test subject 135 is unable to provide a valid, medical explanation for a positive test result, the medical review computer can transmit a verification of the test result to the MRO computer 132, which can transmit the initial test results (e.g., the positive drug test result) to the employer computer 127.

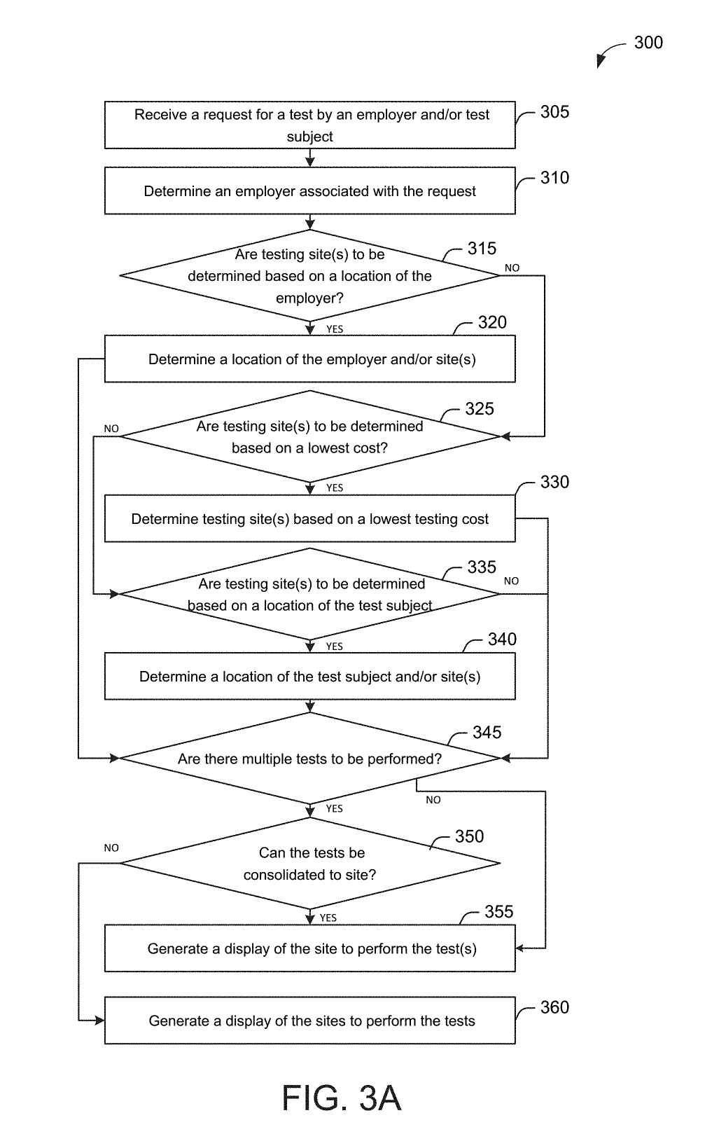

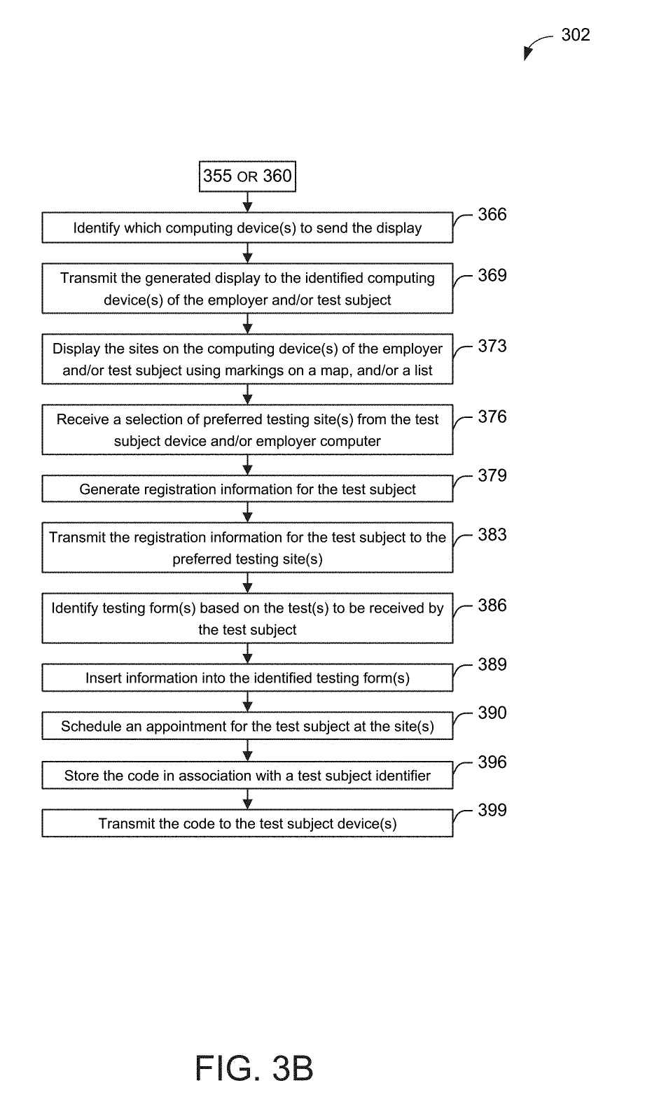

FIGS. 3A and 3B illustrates an example method 300 for scheduling test subject screenings in accordance with one example embodiment of the disclosure. Referring now to FIGS. 1-3B, the example method 300 begins at the START block and proceed to block 305, where the MRO computer 132 can receive a request for a test to be completed on a test subject 135 from an employer and/or the test subject 135. In one embodiment, the MRO computer 132 can receive the request for a test from the employer computer 127 associated with the employer. In another embodiment, the MRO computer 132 can receive the request for the test from the test subject device 130 for the test subject 135. In certain example embodiments, the request for a test can be made by the employer or test subject 135 entering information into a corresponding electronic form provided on the test subject device display, on the employer computer 127 of the employer, or any other connected electronic device. In another example, the request for the test can be received by the MRO computer 132 by the employer (via the employer computer 127) and/or test subject 135 or other user sending a predetermined form of electronic communication (e.g., an email, a text, and/or any other suitable electronic communication) to the MRO computer 132.

At block 310, the MRO computer 132 can determine an employer associated with the test request. In one embodiment, the test request can be an electronic form having a multitude of data fields. Each data field can be associated with receiving a particular form of data, including one or more data fields that include identifying information of the employer. In one example, the employer identifier information can include an account identifier associated with the employer, an employer address, an employer name, an employer phone number, an employer email address, etc. that can be used by the MRO computer 132 to determine an employer identified in the request. For example, the MRO computer 132 can identify the employer identified in the test request by comparing the employer identifier data in the test request to a table, schedule, or database of employer identifier data to identifying a matching record that include matching employer identifier data.

At block 315, an inquiry is conducted by the MRO computer 132 to determine whether the testing site(s) for conducing the one or more tests in the test request are to be determined based on a location of the employer. In one example, the MRO computer 132 can include a set of predetermined rules that have been predefined, for example, based on the employer's business needs. In certain example embodiments, the set of predetermined rules can be included with the matching record identified in block 310 or linked to that matching record. The rules can be configured so that that the testing site(s) are determined based on a location of the employer, possibly in combination with one or more of: the location of the test subject 135, a cost of the requested test to the employer, a predetermined preference by the employer for a given testing site (for example, due to an agreement between the employer and the testing site), and the like. In one embodiment, the predetermined rules can be used to filter the testing site(s) for those testing site(s) that have an associated location that is below a predetermined distance threshold with respect to the employer, possibly in addition to a predetermined distance threshold with respect to the test subject 135, and/or any other predefined landmark or point of reference. If the testing site(s) are to be determined based on a location of the employer, the YES branch is followed to block 320. Otherwise, the NO branch is followed to block 325.

If the MRO computer 132 determines that the testing site(s) are to be determined based on a location of the employer, then at block 320, the MRO computer 132 determines a location of the employer and/or the testing site(s). In one embodiment, the MRO computer 132 can access a database that stores various locations of employers and/or testing site(s), and can search the database to determine the location of the employer and/or site(s). For example, the employer can be determined based on information in the matching record identified in block 310. In another embodiment, the location of the employer and/or testing site(s) can be preprogrammed into the database, for example, whenever an employer registers with the MRO computer 132 or other computers running the operations disclosed herein. In one embodiment, the Internet, including one or more websites (for example, search engine websites) can be used by the MRO computer 132, the test subject device 130, and/or other computers accessible to the MRO computer 132, to search for the location of the employers and/or the test sites, and/or to find updated locations of the employer and/or the test site(s), in situations where the employer and/or the test site(s) moves. The process then continues to block 345.

If the MRO computer 132 determines that the testing site(s) are not to be determined based on a location of the employer, then, an inquiry is conducted at block 325 by the MRO computer 132 to determine whether the testing site(s) are to be determined based on a lowest cost to perform the test(s). In one embodiment, the MRO computer 132 can include a set of predetermined rules for determining which testing sites to use in particular situations that have been predefined, for example, based on the employer's business needs. For example, the rules can be configured so that that the testing site(s) is determined based on the cost that the employer is charged by the testing site to complete the requested test. In certain example embodiments, the set of predetermined rules can be included with the matching record identified in block 310 or linked to that matching record. The predetermined rules can be used to filter the testing site(s) for those testing site(s) that have an associated test cost below a predetermined threshold. If the testing site(s) are to be determined based on a lowest cost to perform the test(s), then the YES branch is followed to block 330. Otherwise, the NO branch is followed to block 335.

If the MRO computer 132 determines that the testing site(s) are to be determined based on a lowest cost to perform the test(s), then at block 330, the MRO computer 132 can determine the testing site(s) to recommend based on a lowest cost charged by the testing site(s) to complete the requested test(s). For example, the MRO computer 132 can access a database that stores the costs of tests associated with the various testing sites and can order the testing sites based on cost to complete the tests in the received request. In another embodiment, the costs of tests associated with the various testing sites can be preprogrammed into the database. In one embodiment, the Internet, including one or more websites (for example, search engine websites) can be used by the MRO computer 132, the test subject device 130, and/or other computers accessible to the MRO computer 132, to search for the costs of tests associated with the various testing sites, and/or to find updated costs of tests associated with the various testing sites, in case, the costs of tests associated with the various testing sites changes over time.

Alternatively or additionally, the MRO computer 132 can determine one or more test sites based on a cost associated with the services provided by each particular test site for the test requested. For example, the matching employer record identified in block 310 can include one or more rules for identifying and scheduling testing sites for test requests for the employer or can include linking information to other databases or memory including this information for the employer. These rules can include an indicator to schedule the testing of the test subject 135 with a testing site having the lowest cost within a particular geographic area. The MRO computer 132 can determine, based on the type of test requested one or more testing sites within the predetermine geographic range or threshold distance of the employer or test subject 135 that can complete the test on the test subject within the predetermined amount of time and/or before a threshold completion date. After determining the one or more testing sites, the MRO computer 132 can identify the test site or combination of test sites that can complete the one or more requested tests in the test request on the test subject 135 at the lowest cost. The process then continues to block 345.

If the MRO computer 132 determines that the testing site(s) are not to be determined based on a lowest cost to perform the test(s), then at block 335, an inquiry can be conducted by the MRO computer 132 to determine whether the testing site(s) are to be determined based on a location of the test subject 135. In one embodiment, the MRO computer 132 can include a set of predetermined rules that have been predefined, for example, based on the employer's business needs. For example, the rules can be configured so that that the testing site(s) is determined based on the location of the test subject 135 (and not on the lowest cost to perform the test(s). In certain example embodiments, the set of predetermined rules can be included with the matching record identified in block 310 or linked to that matching record. If the test sites to suggest are to be determined based on the location of the test subject 135, the YES branch is followed to block 340. Otherwise, the NO branch is followed to block 345.

If the MRO computer 132 determines that the testing site(s) are to be determined based on a location of the test subject 135, then at block 340, the MRO computer 132 can determine a location of the test subject 135 and/or testing site(s). In one example, the location (for example, a global positioning system location) of a test subject device 130 and/or a test subject 135 can be determined by the MRO computer 132. For example, the test subject device can transmit a current set of GPS coordinates for the test subject device 130 or the MRO computer 132 can access the GPS system of the test subject device 130 via an application-enabled service and can retrieve the GPS coordinates of the test subject device 130. In another embodiment, the determination of the location of the test subject device 130 and/or a test subject 135 by the MRO computer 132 can be performed by sending instructions to the test subject device 130 specifying the location of one or more predetermined location(s) (for example, a collection site location, a clinic location, a medical testing site location, a lab location, an employer location, and/or any other suitable location). Further, the MRO computer 132 can send instructions to the test subject device 130 to send an update to the MRO computer 132 that the device 130 is within a given threshold distance (for example, 1 mile or less) to the predetermined location(s) (for example, the collection site location, the clinic location, the medical testing site location, the lab location, the employer location, and/or any other suitable location). Accordingly, the MRO computer 132 can determine the location of the test subject 135 based on the information received from the test subject device 130.

Further, in one embodiment, the MRO computer 132 can access a database that stores various locations of testing site(s) and can search the database to determine the location of the testing site(s). In another embodiment, the location of the testing site(s) can be preprogrammed into the database accessible by the MRO computer 132. In one embodiment, the Internet, including one or more websites (for example, search engine websites) can be used by the MRO computer 132, the test subject device 130, and/or other computers accessible to the MRO computer 132, to search for the location of the testing site(s), and/or to find updated locations of the testing site(s), in case, the testing site(s) have moved.

At block 345, an inquiry is conducted by the MRO computer 132 to determine whether the test request includes a request for multiple tests to be performed. In one example, the determination of whether there are multiple tests to be performed can be based at least in part on the request for the tests by the employer and/or test subject 135, for example, as described in connection with block 305. The MRO computer 132 can evaluate one or more fields of the test request to determine the one or more tests that are being requested. For example, each field can include a code and the MRO computer 132 can compare the code in the field of the test request to a table or schedule of test codes in the database accessible by the MRO computer 132 to determine which test or tests are being requested for the test subject 135. For example, the employer and/or the test subject 135 may request one, two, three, four, or more tests, which may or may not be medically related tests. For example, the employer and/or test subject 135 may request a drug test, immunization tests, and/or other types of tests. If the MRO computer 132 determines that multiple tests are to be performed on the test subject, the YES branch is followed to block 350. Otherwise, the NO branch is followed to block 355.

If the MRO computer 132 determines that there are multiple tests to be performed on the test subject 135, then at block 350, an inquiry is conducted by the MRO computer 132 to determine whether more than one of the tests in the test request can be consolidated and completed at a single testing site. In one embodiment, the consolidation of tests to a single testing site can be based at least in part on the capabilities of the particular testing site(s). For example, some testing sites can perform multiple types of tests, and others may be less sophisticated, only offering one or a limited number of test that it can conduct. For example, a medical test and a drug test can be simultaneously performed at a doctor's office in certain example embodiments. In one embodiment, the consolidation of the testing sites can be based at least in part on the location of the testing sites. For example, if the multiple tests are to be performed at testing sites that have distances between one another that are beyond a predetermined threshold, the MRO computer 132 can consolidate the testing sites to those having distances between one another that are below the threshold. Alternatively, or additionally, the MRO computer 132 can reduce the number of testing sites while increasing the cost to the employer and/or test subject 135 to complete the tests using fewer testing sites.

In one embodiment, the MRO computer 132 can access a database that stores various capabilities of the testing site(s), and can search the database to determine the capabilities of the testing site(s) in order to determine if two or more of the tests can be consolidated and completed at a single testing site. In another embodiment, the capabilities of the testing site(s) can be preprogrammed into the database and can be evaluated at the database to determine if two or more of the tests can be consolidated and completed at a single testing site. In one embodiment, the Internet, including one or more websites (for example, search engine websites) can be used by the MRO computer 132 to search for the capabilities of the testing site(s), and/or to find updated capabilities of the testing site(s), in case, the capabilities of the testing site(s) change over time. If the two or more of the tests in the test request can be consolidated into a single testing site, the YES branch is followed to block 355. Otherwise, the NO branch is followed to block 360.

If the MRO computer 132 determines that there are not multiple tests to be performed, then at block 355, the MRO computer 132 can generate a display of the site to perform the test. Alternatively, or additionally, if there are multiple tests to be performed, but at least two of the requested tests can be consolidated to one site, then at block 355, the MRO computer 132 can generate a display of the site to perform the multiple tests. In one embodiment, the display of the site(s) to perform the test(s) can be displayed on the employer's computer 127 and/or the test subject device 130. In another embodiment, the MRO computer 132 can generate the display for presentation to the test subject 135 at a user interface screen (similar, but not necessarily identical to, the user interface screen 215, as further shown and described in connection with FIG. 2).

If multiple tests in the test request cannot be consolidated to one site, then at block 360, the MRO computer 132 can generate a display of the sites to perform the tests. In one embodiment, the display of the sites to perform the tests can be transmitted to and displayed on the employer's computer 127 and/or the test subject device 130 from the MRO computer 132 via the network 104. In another embodiment, the MRO computer 132 can generate the display for presentation to the test subject 135 at a user interface screen (similar, but not necessarily identical to, the user interface screen 215, as further shown and described in connection with FIG. 2).

At block 366, the MRO computer 132 identifies which computing device(s) to send the display. In one embodiment, the MRO computer 132 can include a set of predetermined rules that have been predefined, for example, based on the employer's business needs and/or preferences. For example, the rules can be configured so that that the MRO computer 132 identifies the test subject device 130 of the test subject 135 as at least one of the computing device(s) to send the display. For example, the rules can be configured so that that the MRO computer 132 identifies an employer computer 127 or a testing site computer as other computing device(s) to send the display. In another embodiment, the rules can be configured so that that the MRO computer 132 identifies any other associated computer as a computing device to send the display. In certain example embodiments, the set of predetermined rules can be included with the matching record identified in block 310 or linked to that matching record.

At block 369, the MRO computer 132 transmits the generated display to the identified computed device(s) of the employer and/or test subject 135. In one embodiment, the transmission of the generated display to the identified computed device(s) of the employer (e.g., the employer computer 127) and/or test subject 135 can be performed over the network 104 (e.g., the Internet). In one embodiment, the network 104 can include a wireless network and/or a wired network.

At block 373, the MRO computer 132 can display the identified testing sites on the computing device(s) of the employer (e.g., employer computer 127) and/or test subject 135 (e.g., test subject device 130) using markings on a map, and/or a list of testing sites. In another example embodiment, the MRO computer 132 can generate a display of the list of the testing sites, arranged in order of cost and/or location (e.g., distance from one or both of the employer associated with the employer computer 127 and the test subject 135), and can transmit that display of the list of testing sites to the test subject device 130 and/or employer computer 127 in a list format, for example, through an application on the test subject device 130 or an employer's computer 127. The list may, in various example embodiments, be arranged in order of increasing or decreasing cost, location, and/or another parameter.

In one example embodiment, the employer can integrate a user interface module (not shown) provided by the MRO computer 132 in a website, mobile site, and/or other software application for the employer computer 127 and/or the test subject device 130. The user interface module can be used to integrate seamlessly with the employers pre-existing website, mobile site, and/or other software application.

At block 376, the MRO computer 132 can receive a selection of preferred testing site(s) from the test subject device 130 and/or the employer computer 127. In one example, the test subject 135 and/or employer associated with the employer computer 127 can optionally chose one testing site from among the one or more testing sites shown on the display of the testing sites on the computing device(s) 127, 130, and the selection can be transmitted to and received by the MRO computer 132 via, for example, the network 104. For example, the employer and/or the test subject 135 can enter information describing the selection of the preferred testing site(s) into the embedded user interface module on the test subject device 130 and/or the employer computer 127.

At block 379, the MRO computer 132 can generate registration information for the test subject 135. For example, the MRO computer 132 can receive test subject identifying information from a test subject 135, for example, a test subject's name, test subject's address, test subject's date of birth, test subject's social security number, and the like. Alternatively, the test subject identifying information can be included in the test request and the MRO computer 132 can parse the test request to identify and retrieve the test subject identifying information. The MRO computer 132 may use this information in registering or pre-registering the test subject 135 for the one or more tests at one or more testing sites (e.g., collection site(s), lab site(s), clinical testing site(s), and/or medical testing site(s)).

At block 383, the MRO computer 132 can transmit the registration information for the test subject 135 to the preferred and/or selected testing site(s). In one example, the registration information can include the test subject identifying information, the employer identifying information, the tests to be conducted on the test subject 135, an appointment time and/or date for the test, an expiration date to complete the tests (if applicable) and contact information for both the employer and the test subject 135 (e.g., phone number, email address, etc.). In one embodiment, the transmission of the registration information for the test subject 135 to the preferred testing site(s) can be performed over the network 104 (e.g., the Internet).

At block 386, the MRO computer 132 can identify testing form(s) based on the test(s) to be received by the test subject 135. For example, the MRO computer 132 can parse the test request and identify each test that the test subject 135 is to receive. In one example, each test is represented by a code (e.g., numeric code or alphanumeric code, bar code, QR code, or the like) and the MRO computer 132 can use the code to search for associated forms in the database by identifying forms with a matching code. The MRO computer 132 can then identify forms related to the scheduling, administration, and/or legal requirements associated with the test(s). In one example embodiment, the forms can be sent to a test subject device 130 associated with the test subject 135 for completion. For example, the forms may include a drug screening form that has various fields to be filled out by the test subject 135. In one example embodiment, the forms may include a bar code for identification of the requested test. In another example, the forms may include a medical and/or clinical form for completion and printing by the test subject 135 using a test subject device 130. In one example embodiment, the completed forms may be stored at the MRO computer 132 or a software module associated with the MRO computer 132. For example, the completed forms can be stored in a Passbook app module associated with the MRO computer 132.

At block 389, the MRO computer 132 can insert information into the identified testing form(s). For example, the MRO computer 132 can produce information (for example, a test subject's name, test subject's address, test subject's date of birth, test subject's social security number, the type of test to be completed, employer identifying information, and the like) for insertion into one or more testing forms, for example, for compliance with various local, state, and/or federal laws. For example, the medical testing site computers 125 may generate a form in order to comply with local and/or federal laws.

In one example embodiment, the MRO computer 132 can generate, customize and manage testing forms, for example, medical forms. The MRO computer 132 can then identify, based at least in part on the test(s) requested, one or more individual medical forms which are required to support the medical test. The MRO computer 132 can populate the testing forms with at least the received test subject information (for example, a name, an address, birth date, a phone number, a social security number, a health insurance claim number, an email address and the like) received from the test subject device 130 or the test request and any received information from the employer computer 127. In one example embodiment, a client/server infrastructure or a cloud based infrastructure may be implemented to provide one or more local and remote clients (for example, testing site computers, employers, etc.) access to the testing form customization according to the disclosed embodiments.

At block 390, the MRO computer 132 can schedule an appointment for the test subject 135 at the selected and/or preferred testing site(s). In one example embodiment, the MRO computer 132 may schedule the appointment for the test subject 135 taking test(s) (for example, medical test(s)) at the testing site(s) based on an availability of the testing site(s), a test subject schedule, and/or an employer schedule (for example, an employer deadline to complete the testing and receive results). In one embodiment, the MRO computer 132 can schedule the appointment for the test subject 135 at the site(s) by accessing a network associated with a computer at the testing site(s) and transmitting information to that computer to schedule the test subject 135 for the test at the testing site(s). For example, the MRO computer 132 can schedule the appointment for the test subject 135 at the testing site(s) by filling out one or more electronic forms associated with the testing site indicative of the test subject 135 being available for testing at a particular date and time at the testing site(s). In one embodiment, the MRO computer 132 may receive an identifier, for example, an alphanumeric code, barcode, or QR code, from the particular testing site computer to indicate that the test subject 135 has been registered or pre-registered for the test at the appointed time. In another embodiment, the MRO computer 132 can send the received code to the test subject device 130 for presentation to the site computer and/or to a person at the testing site prior to testing. Alternatively or additionally, the MRO computer 132 can send the registration or pre-registered information via a pass on an Apple Passbook to the test subject device 130 of the test subject 135.

At block 396, the MRO computer 132 can store the code in association with one or more test subject identifier information. In one example embodiment, the completed forms may be stored at the MRO computer 132 (for example, in non-transitory memory at a server associated with the MRO computer 132), or a software module associated with the MRO computer 132, for example, in a Passbook app module associated with the MRO computer 132 and/or test subject device 130. In another embodiment, the completed forms may be stored at the MRO computer 132 on a cloud-based server.

At block 399, the MRO computer 132 can transmit the code to the test subject device(s) 130. In one embodiment, the transmission of the code to the test subject device(s) 130 can be performed over the network 104. In one embodiment, the code can be displayed on the test subject device(s) 130. In another embodiment, the code can be displayed on the user interface screen (similar, but not necessarily identical to, the user interface screen, as further shown and described in connection with FIG. 2).

In one example embodiment, the MRO computer 132 can configure the test subject device 130, including a Wallet app on the test subject device 130 to display Aztec, PDF417 and QR 2D barcodes and Code 128 1D barcodes based in part on the transmitted code. In one embodiment, the code can include a digital coupon or ticket and can be referred to as a “pass.” The pass can be presented to the staff of the testing site(s) by the test subject 135 when the test subject 135 goes for the administration of the one or more tests at the testing site. Passes can also be distributed online via Safari, sent to the test subject 135 via email, or scanned using the built-in scanner in the Wallet app. Passes can also be synced between iOS devices using iCloud, and OS X 10.8.2 and higher also support opening passes to be sent to test subject's iOS devices.

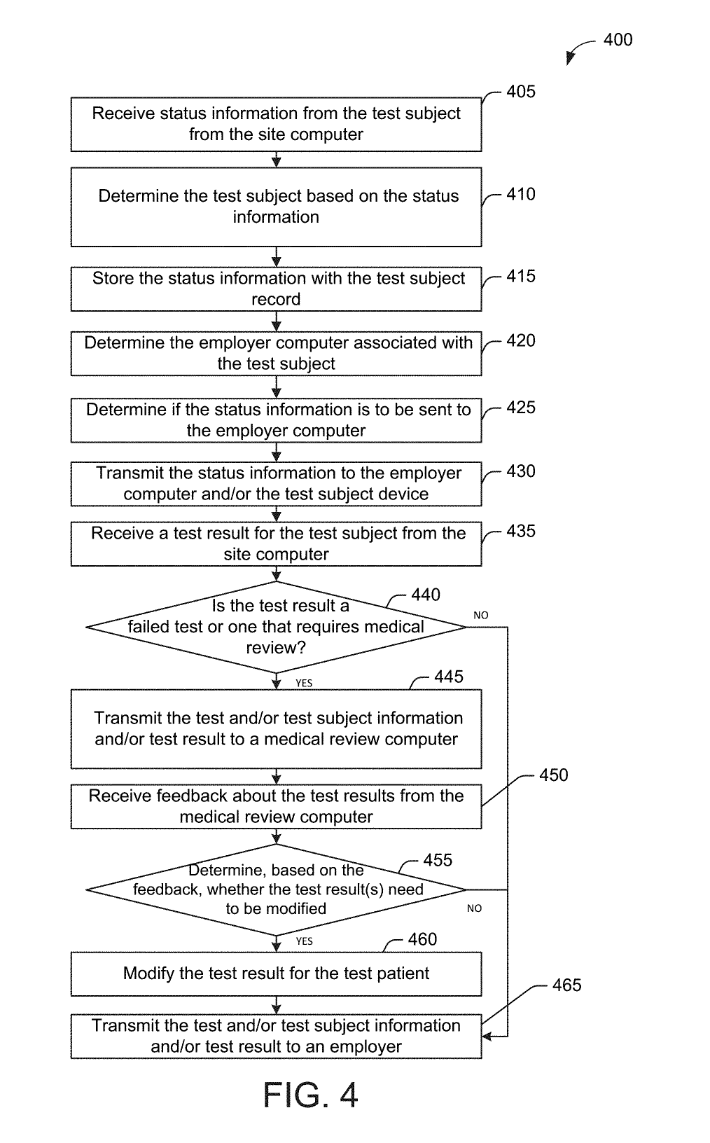

FIG. 4 illustrates an example method 400 of receiving status updates and results of a screening of a test subject 135 in accordance with one example embodiment of the disclosure. The process begins at block 405, where the MRO computer 132 receives status updates and/or results of the testing of a test subject 135 from the testing site computer (e.g., collection site computer 105, lab computer 110, clinical testing site computer 120, medical testing site computer 125 or multiples of any of the preceding computers) at the respective testing site (e.g., collection site, lab, clinical testing site, and/or medical testing site). In one example embodiment, the MRO computer 132 can receive status information from the testing site computer at any point in the pre-test, testing, or post-test process for the test subject 135. In various example embodiments, one or more test site computers can send and receive information, for example, status information, to and from the MRO computer 132. In one example embodiment, the status information can be provided at least in part by the staff of the testing sites based on inputs into the respective testing site computer. For example staff member at the testing site can enter in data into the particular testing site computer as to the status of the test being conducted on the test subject. This status update can be transmitted to the MRO computer 132 from the testing site computer via the network 104. For example, the staff of the testing sites may include: a pathologist, a clinical biochemist, a pathologists' assistant (PA), a biomedical scientist (BMS), a medical laboratory scientist (MLS), a medical laboratory technologist, a medical laboratory technician (MLT), a medical laboratory assistant (MLA), and a phlebotomist (PBT), and a data entry operator, among other users. In one example embodiment, the various testing site computers associated with one or more test site(s) can exchange data (for example, status updates related to a test subject 135, scheduling information, and other information) with the MRO computer 132 and/or with other site computers of the screening computing system 102, and with employer computers 127 and/or test subject device(s) 130.

At block 410, the MRO computer 132 determines the test subject 135 based on the status information. In one example embodiment, the MRO computer 132 can track the collection of specimens from the test subject 135 by the one or more testing sites. For example, the collection site can acquire various specimens from the test subject 135, including, but not limited to, a urine specimen, a blood specimen, a hair specimen, a serum specimen, a semen specimen, and the like. In one example embodiment, the MRO computer 132 can receive notifications from the particular testing site computer providing a status update of the administration of various tests by the collection site, for example, an Enzyme Multiple Immunoassay Test (EMIT), a Gas Chromatography Mass Spectrometer (GC MS), a Saliva Drug Testing (Oral Fluid), Blood Drug Testing, and/or a Hair Follicle Testing. In various embodiments, status information can include an indication that the test subject has checked into the collection site. The status information can include an indication that a specimen has been retrieved from the test subject 135, an indication that the test subject 135 or the collection site has begun the testing an indication that the test subject 135 has passed or failed the testing and/or the results of the testing, an indication that there has been some irregularity associated with the testing, and/or an indication that the site, for example, the clinical and/or medical site, needs further information from the test subject 135 and/or the employer, for example, prior to proceeding with the test. For example, the testing site may require a social security number for the test subject 135 prior to proceeding with the test.

At block 415, the MRO computer 132 can store the status information with the test subject record for the test subject 135. In one example embodiment, the status updates may be stored at the MRO computer 132 (for example, in non-transitory memory at a server associated with the MRO computer 132), or a software module associated with the MRO computer 132, for example, in a Passbook app module associated with the MRO computer 132. In another embodiment, the status updates may be stored at the MRO computer 132 on a cloud-based server.

At block 420, the MRO computer 132 can determine the employer computer 127 associated with the test subject 135 and/or the test request. In one embodiment, an account identifier associated with the employer and/or test subject 135 or other suitable information can allow the MRO computer 132 to determine an employer computer 127 associated with the test subject 135. For example, the MRO computer 132 can determine the employer computer 102 by comparing the test subject identifier information, the account identifier, or other information to data in one or more databases available to the MRO computer 132 to identify a matching record and from the matching record the employer computer 127 identified or otherwise associated with the matching record. In another embodiment, the employer computer 127 associated with the test subject 135 can be preprogrammed into the database(s). In another embodiment, the Internet, including one or more websites (for example, search engine websites) can be used by the MRO computer 132 to search for the employer computer(s) 127 associated with the test subject 135, and/or to find updated employer computer(s) 127 associated with the test subject 135, in case, the employer computer(s) 127 associated with the test subject 135 changes over time.

At block 425, the MRO computer 132 can determine if the status information is to be sent to the employer computer 127. Further, the MRO computer 132 can determine, for example based on the employer identifier in the test request, if the status information (for example, a status update) should be transmitted to the employer computer 127 via the network. For example, the MRO computer 132 can compare the employer identifier from the test request to a schedule of employer identifiers in, for example, a database or other memory to identify a matching record that includes the same employer identifier. The matching record can include one or more rules for transmitting status information (e.g., if status information is transmitted, which status information is grouped before transmitting, which types of status information is transmitted) on testing to an employer computer 127. Based on those rules, the MRO computer 132 can, if the rule is satisfied, transmit the status information to the employer computer 127.

At block 430, the MRO computer 132 can transmit the status information to the employer computer 127 and/or the test subject device 130 via, for example, the network 104. For example, the MRO computer 132 may transmit a first status information to the employer computer 127 upon the completion and/or shipping of the chain of custody form and/or specimen, reporting a client altering or substituting a specimen, reporting that the urine specimen is outside the normal temperature range (32.5° C., 90.5°-99.8° F.) and the test subject 135 will not allow an oral body temperature to be taken, and/or the oral body temperature is 1° C./1.8° F. different from the temperature of the specimen, reporting that the collection site person observed behavior that clearly indicates an attempt to alter or substitute a specimen or otherwise circumvent the test procedure and/or reporting a “split sample” of the biospecimens. In the split sample method the biospecimen, for example, a urine specimen, is divided into two containers. Further, the MRO computer 132 may transmit status information to an employer computer 127 reporting a failure on the part of the test subject 135 to provide an adequate amount of a bio specimen, for example, at least 45 ml (milliliters) of urine, reporting that the test subject 135 was unable to provide the minimum amount of urine, and/or that the collection site is having the client drink up to 24 ounces of fluid and try to provide a sample within two hours, and/or reporting that the test subject 135 is still unable to provide a complete sample, and that the test is stopped.

In one example embodiment, the results of the test can be transmitted via the network 104 to one or more employer computers 127, each associated with a different employer, through the MRO computer 132. The communication can be in the form of a XML delivery, a webservice, a PDF file, and the like. In another example embodiment, the results can be transmitted to the test subject 135, for example, through the test subject device 130. The results can be electronically transmitted to the test subject device 130 if the local laws permit. In one example embodiment, the results can be transmitted to the test subject device 130 only if the employer associated with the employer computer 127 has previously agreed. For example, the employer computer 127 may be required to transmit and the MRO computer 132 receive a notification that the employer allows the test subject 135 to receive the results of the test.

At block 435, the MRO computer 132 can receive a test result for the test subject 135 from the testing site computer. In one example embodiment, the result of the test can be received, for example, in the form of a Portable Document Format (PDF) file, an XML file, a webservice, or any other kind of electronic file and/or communication from the testing site computer. At block 440, an inquiry can be conducted by the MRO computer 132 to determine whether the test results represent a failed test or one that requires medical review. For example, the MRO computer 132 can analyze the test results received in order to determine that the test resulted in a failed test or that the test results require further medical review, for example, by a licensed physician. If the test result is a failed test result that requires medical review, the YES branch can be followed to block 440. Otherwise, the NO block can be followed to block 465. In the case where the test results require medical review, the MRO computer 132 can determine (via various authentication procedures) the medical review computer(s) associated with an operator that meets one or more of the following requirements: a licensed a medical doctor (MD) or doctor of osteopathic medicine (DO), knowledgeable about substance abuse disorders, plus clinical experience, certified by a nationally recognized MRO certification board. The authentication procedures can include, receiving, by the MRO computer 132, a credential, certificate, a standardized identifier, a signature, and the like, from the medical review computer.

If the MRO computer 132 determines that the test results require medical review, then at block 445, the MRO computer 132 can transmit the test and/or test subject information and/or test result to the identified medical review computer. In one example embodiment, the MRO computer 132 can transmit to the medical review computer the test results received from one or more testing site computers so that the physician associated with the medical review computer may review the results to make sure the correct test panel was performed and that the correct procedures were followed by the testing site. The MRO computer 132 can also transmit a checklist to the medical review computer to ensure a proper review by the physician associated with the medical review computer of the test results.

In another embodiment, the MRO computer 132 can send positive results to a medical review computer associated with a physician for further review by a licensed physician, for review prior to sending the result of the test to the employer computer 127 and/or the test subject device 130. If the MRO computer 132 receives an indication from the medical review computer that the physician determined that the test is invalid or that further testing needs to be performed, the MRO computer 132 may not send the results to the employer computer 127 associated with the employer identified in the test request. The MRO computer 132 may instead transmit to the employer computer 127 and/or the test subject device 130, via an electronic communication, that the test was invalid, that the test needs to be redone, and/or that further testing needs to be performed. For example, the MRO computer 132 can transmit the results of the test via the network 104 to an employer computer 127, but not report the results of the test to the test subject device 130. In another embodiment, the MRO computer 132 can report the results of the test via the network 104 to a third party entity, for example, a recruiting firm that does not reveal the details of the results of the test to the employer and/or the test subject 135, but rather provides a binary pass or fail result to the employer (e.g., at the employer computer 127) and/or the test subject 135 (e.g., at the test subject device 130) based on predetermined criteria. The predetermined criteria may be, for example, one or more parameter(s) associated with the test(s) exceeding a threshold.

If the MRO computer 132 determines that the test results do not require medical review, then at block 465, the MRO computer 132 can transmit the test results and/or test subject information to an employer associated with the employer computer 127 via, for example, the network 104. In one example embodiment, the MRO computer 132 can transmit the test results and/or test information in the form of a Portable Document Format (PDF) file, an XML file, a webservice, or any other kind of electronic file and/or communication from the MRO computer 132.

At block 450, the MRO computer 132 can receive feedback about the test results from the medical review computer via, for example, the network 104. In one example embodiment, the MRO computer 132 can receive the feedback about the test results from the medical review computer in the form of a Portable Document Format (PDF) file, an XML file, a webservice, or any other kind of electronic file and/or communication from the medical review computer.

The MRO computer 132 can also receive feedback in the form of notes and updated specimen-related information in the record of the test subject 135 from the medical review computer in connection with the test associated with the test results. In one embodiment, when a drug test is reported positive by the testing site computer, the medical review computer may also contact the test subject 135 (e.g., the job applicant) through the MRO computer 132 and/or the test subject device 130 to determine if there is a legitimate medical explanation for the positive drug test result or other test results under review. For example, some prescription medications, dietary requirements, or medical treatments can cause a false positive test result. In these cases, the medical review computer can receive verification of a valid prescription, dietary requirement, or recent medical treatment on the test subject 135 independently, or through the MRO computer 132. The false positive test result or any other test result under review and deemed to be faulty can then be transmitted to the employer computer 127 through the MRO computer 132 as a negative or other result because there is a legitimate, verified medical reason for the false positive test result or other incorrect test result.

At block 455, an inquiry can be conducted by the MRO computer 132 to determine, based on the feedback, whether the test result(s) need to be modified. In one example embodiment, the MRO computer 132 may integrate with a medical review computer that receives and can facilitate examination and review of all positive drug test results and any other positive, negative, or other types of test results as desired or required under federal, state, or local regulations, to determine if there is an alternative medical explanation for the received test result. Before making a final decision as to whether a test result is valid, a licensed physician associated with the medical review computer can provide the employee with the opportunity to discuss the test result. If the physician determines there is a legitimate medical explanation for the positive test result, the MRO computer 132 can determine to modify the test result(s) to reflect this explanation, and/or determine to modify the test result(s) accordingly. If the test result needs to be modified, the YES branch can be followed to block 460. Otherwise, the NO branch can be followed to block 465.

If the MRO computer 132 determines, based on the feedback, that the test result(s) need to be modified, then at block 460, the MRO computer 132 can modify the test result for the test subject 135, and then proceed to 465. The MRO computer 132 can, based on feedback received from the medical review computer, modify the test result(s) including to reflect the explanation provided by the test subject 135. For example, the MRO computer 132 can alter any information presented on a document (for example, a Portable Document Format (PDF) file, an XML file, a webservice, or any other kind of electronic file and/or communication) reflecting the test results.

At block 465, the MRO computer 132 can transmit the test results and/or test subject information to an employer computer 127 associated with the employer identified in the test request via the network 104. In one example embodiment, the MRO computer 132 can transmit the test results and/or test subject information in the form of a Portable Document Format (PDF) file, an XML file, a webservice, or any other kind of electronic file and/or communication from the MRO computer 132.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infra-Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Additionally, the various aspects of the disclosure and the operations of the MRO computer 132 are implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problems addressed by the disclosure. Accordingly, the various aspects of the disclosure improve the functioning of the system overall in its specific implementation to perform the process set forth by the disclosure and as defined by the claims.

Aspects of the disclosure may include a server executing an instance of an application or software configured to accept requests from a client and giving responses accordingly. The server may run on any computer including dedicated computers. The computer may include at least one processing element, typically a central processing unit (CPU), and some form of memory. The processing element may carry out arithmetic and logic operations, and a sequencing and control unit may change the order of operations in response to stored information. The server may include peripheral devices that may allow information to be retrieved from an external source, and the result of operations saved and retrieved. The server may operate within a client-server architecture. The server may perform some tasks on behalf of clients. The clients may connect to the server through the network on a communication channel as defined herein. The server may use memory with error detection and correction, redundant disks, redundant power supplies and so on.

Embodiments of the present disclosure may be implemented in various ways, including as computer program products that include articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one example embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one example embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described above with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

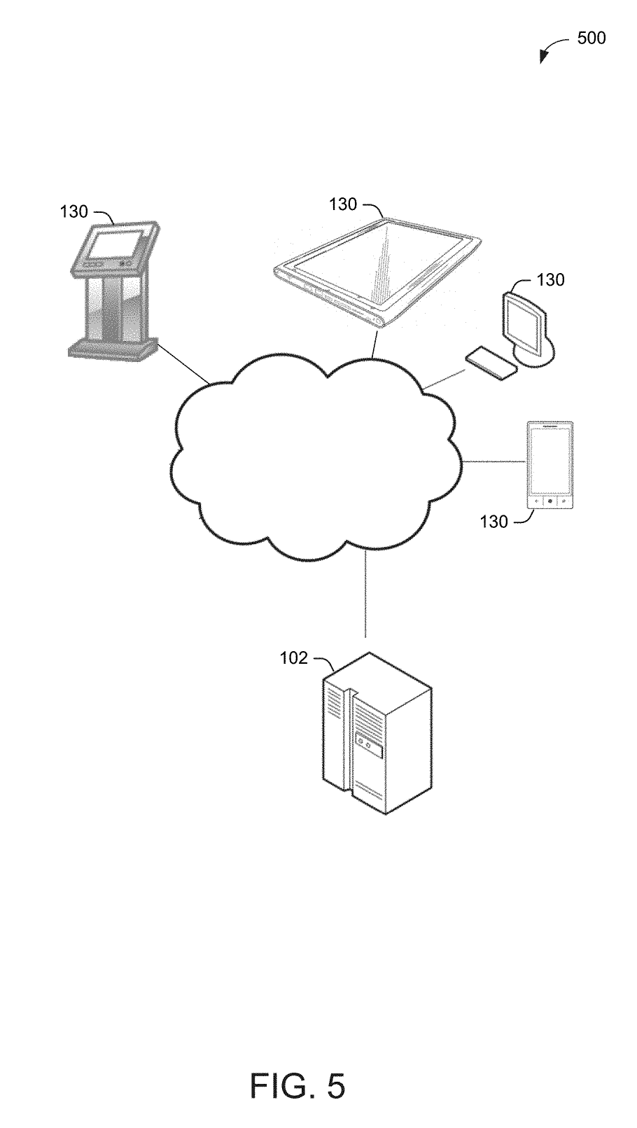

FIG. 5 provides an illustration of an example system that can be used to practice embodiments of the present disclosure. As shown in FIG. 5, this particular embodiment may include one or more screening computing entities 500, one or more networks 505, and one or more test subject device computing entities 130. Each of these components, entities, devices, systems, and similar words used herein interchangeably may be in direct or indirect communication with, for example, one another over the same or different wired or wireless networks. Additionally, while FIG. 5 illustrates the various system entities as separate, standalone entities, the various embodiments are not limited to this particular architecture.

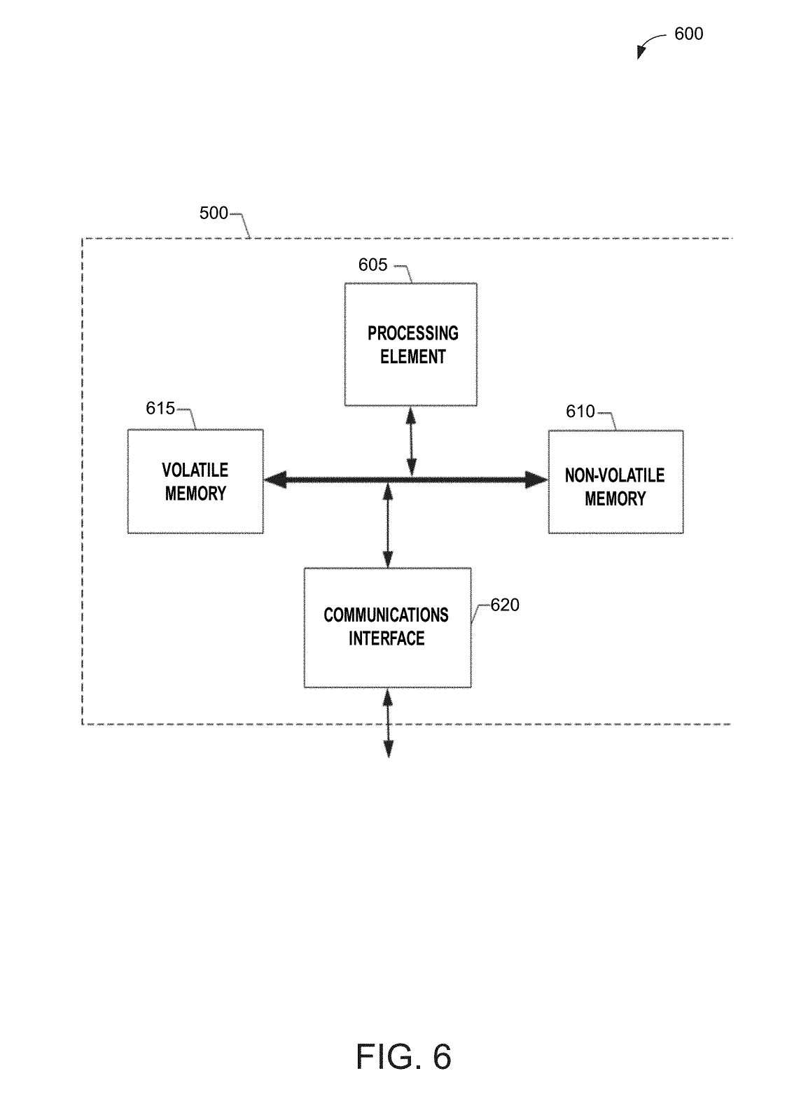

FIG. 6 provides a schematic view of a screening computer system 500 according to one embodiment of the present disclosure. In general, the terms computing entity, computer, entity, device, system, and/or similar words used herein interchangeably may refer to, for example, one or more computers, computing entities, desktop computers, mobile phones, tablets, phablets, notebooks, laptops, distributed systems, gaming consoles, watches, glasses, iBeacons, proximity beacons, key fobs, radio frequency identification (RFID) tags, ear pieces, scanners, televisions, dongles, cameras, wristbands, wearable items/devices, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one example embodiment, these functions, operations, and/or processes can be performed on data, content, information, and/or similar terms used herein interchangeably.

As indicated, In one example embodiment, the screening computer system 500 may also include one or more communications interfaces 620 for communicating with various computing entities, such as by communicating data, content, information, and/or similar terms used herein interchangeably that can be transmitted, received, operated on, processed, displayed, stored, and/or the like. For instance, the carrier computing entity 600 may communicate with test subject computing entities 130 and/or a variety of other computing entities.

As shown in FIG. 6, the carrier computing entity 600 may include or be in communication with one or more processing elements 605 (also referred to as processors, processing circuitry, and/or similar terms used herein interchangeably) that communicate with other elements within the screening computer system 500 via a bus, for example. As will be understood, the processing element 605 may be embodied in a number of different ways. For example, the processing element 605 may be embodied as one or more complex programmable logic devices (CPLDs), microprocessors, multi-core processors, coprocessing entities, application-specific instruction-set processors (ASIPs), microcontrollers, and/or controllers. Further, the processing element 605 may be embodied as one or more other processing devices or circuitry. The term circuitry may refer to an entirely hardware embodiment or a combination of hardware and computer program products. Thus, the processing element 605 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 605 may be configured for a particular use or configured to execute instructions stored in volatile or non-volatile media or otherwise accessible to the processing element 605. As such, whether configured by hardware or computer program products, or by a combination thereof, the processing element 605 may be capable of performing steps or operations according to embodiments of the present disclosure when configured accordingly.

In one example embodiment, the screening computer system 500 may further include or be in communication with non-volatile media (also referred to as non-volatile storage, memory, memory storage, memory circuitry and/or similar terms used herein interchangeably). In one example embodiment, the non-volatile storage or memory may include one or more non-volatile storage or memory media 610, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one example embodiment, the screening computer system 500 may further include or be in communication with volatile media (also referred to as volatile storage, memory, memory storage, memory circuitry and/or similar terms used herein interchangeably). In one example embodiment, the volatile storage or memory may also include one or more volatile storage or memory media 615, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 605. Thus, the databases, database instances, database management systems, data, applications, programs, program modules, scripts, source code, object code, byte code, compiled code, interpreted code, machine code, executable instructions, and/or the like may be used to control certain aspects of the operation of the screening computer system 500 with the assistance of the processing element 605 and operating system.

As indicated, In one example embodiment, the screening computer system 500 may also include one or more communications interfaces 620 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol Similarly, the carrier computing entity 500 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, and/or any other wireless protocol.

Although not shown, the screening computer system 500 may include or be in communication with one or more input elements, such as a keyboard input, a mouse input, a touch screen/display input, motion input, movement input, audio input, pointing device input, joystick input, keypad input, and/or the like. The carrier computing entity 600 may also include or be in communication with one or more output elements (not shown), such as audio output, video output, screen/display output, motion output, movement output, and/or the like. As will be appreciated, one or more of the screening computer system's components may be located remotely from other screening computer system components, such as in a distributed system. Furthermore, one or more of the components may be combined and additional components performing functions described herein may be included in the screening computer system 500. Thus, the screening computer system 500 can be adapted to accommodate a variety of needs and circumstances. As will be recognized, these architectures and descriptions are provided for exemplary purposes only and are not limiting to the various embodiments.

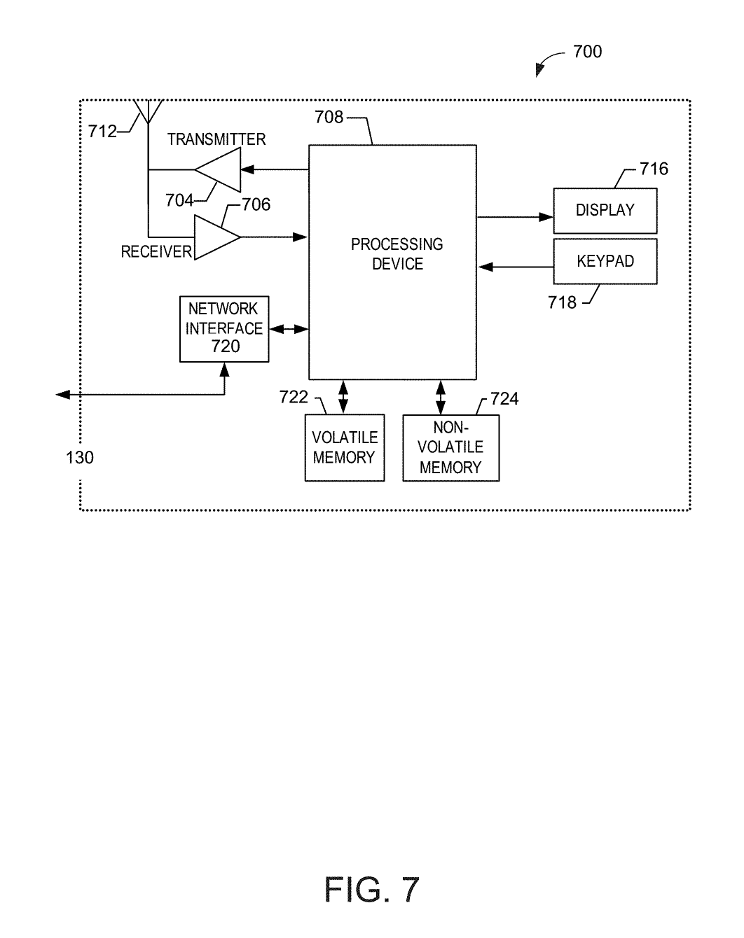

A test subject may be an individual. A test subject or relations may operate a test subject device 130 that includes one or more components that are functionally similar to those of the carrier computing entity 600 of FIG. 6. FIG. 7 provides an illustrative schematic representative of a test subject device 130 that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles, watches, glasses, key fobs, radio frequency identification (RFID) tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. The test subject device 130 can be operated by various parties. As shown in FIG. 7, the test subject device 130 can include an antenna 712, a transmitter 704 (e.g., radio), a receiver 706 (e.g., radio), and a processing element 708 (e.g., CPLDs, microprocessors, multi-core processors, coprocessing entities, ASIPs, microcontrollers, and/or controllers) that provides signals to and receives signals from the transmitter 704 and receiver 706, respectively.

The signals provided to and received from the transmitter 704 and the receiver 706, respectively, may include signaling information in accordance with air interface standards of applicable wireless systems. In this regard, the test subject device 130 may be capable of operating with one or more air interface standards, communication protocols, modulation types, and access types. More particularly, the test subject device 130 may operate in accordance with any of a number of wireless communication standards and protocols, such as those described above with regard to the carrier computing entity 600. In a particular embodiment, the test subject device 130 may operate in accordance with multiple wireless communication standards and protocols, such as UMTS, CDMA2000, 1xRTT, WCDMA, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the test subject device 130 may operate in accordance with multiple wired communication standards and protocols, such as those described above with regard to the carrier computing entity 600 via a network interface 720.

Via these communication standards and protocols, the test subject device 130 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The test subject device 130 can also download changes, add-ons, and updates, for instance, to its firmware, software (e.g., including executable instructions, applications, program modules), and operating system.

According to one embodiment, the test subject device 130 may include location determining aspects, devices, modules, functionalities, and/or similar words used herein interchangeably. For example, the test subject device 130 may include outdoor positioning aspects, such as a location module adapted to acquire, for example, latitude, longitude, altitude, geocode, course, direction, heading, speed, universal time (UTC), date, and/or various other information/data. In one example embodiment, the location module can acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information can be determined by triangulating the test subject device's 130 position in connection with a variety of other systems, including cellular towers, Wi-Fi access points, and/or the like. Similarly, the test subject device 130 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The test subject device 130 may also include a test subject interface (that can include a display 716 coupled to a processing element 708) and/or a user input interface (coupled to a processing element 708). For example, the user interface may be a user application, browser, user interface, and/or similar words used herein interchangeably executing on and/or accessible via the test subject device 130 to interact with and/or cause display of information from the carrier computing entity 600, as described herein. The user input interface can include any of a number of devices or interfaces allowing the test subject device 130 to receive data, such as a keypad 718 (hard or soft), a touch display, voice/speech or motion interfaces, or other input device. In embodiments including a keypad 718, the keypad 718 can include (or cause display of) the conventional numeric (0-9) and related keys (#, *), and other keys used for operating the test subject device 130 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The test subject device 130 can also include volatile storage or memory 722 and/or non-volatile storage or memory 724, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the test subject device 130. As indicated, this may include a user application that is resident on the entity or accessible through a browser or other user interface for communicating with the screening computer system 500 and/or various other computing entities.

In another example embodiment, the test subject device 130 may include one or more components or functionality that are the same or similar to those of the carrier computing entity 600, as described in greater detail above. As will be recognized, these architectures and descriptions are provided for example purposes only and are not limiting to the various embodiments.

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs (i.e., one or more modules of computer program instructions) encoded on computer storage medium for execution by, or to control the operation of, information/data processing apparatus. Alternatively, or in addition, the program instructions can be encoded on an artificially-generated propagated signal (e.g., a machine-generated electrical, optical, or electromagnetic signal), which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry (e.g., an FPGA (field programmable gate array) or an ASIC (application-specific integrated circuit)). The apparatus can also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices (e.g., EPROM, EEPROM, and flash memory devices; magnetic disks (e.g., internal hard disks or removable disks; magneto-optical disks); and CD-ROM and DVD-ROM disks). The processor and the memory can be supplemented by, or incorporated in, special purpose logic circuitry.

To provide for interaction with a test subject or relations, embodiments of the subject matter described herein can be implemented on a computer having a display device (e.g., a CRT (cathode ray tube) or LCD (liquid crystal display) monitor) for displaying information/data to the test subject or relations and a keyboard and a pointing device (e.g., a mouse or a trackball) by which the test subject or relations can provide input to the computer. Other kinds of devices can be used to provide for interaction with a test subject or relations as well; for example, feedback provided to the test subject or relations can be any form of sensory feedback (e.g., visual feedback, auditory feedback, or tactile feedback) and input from the test subject or relations can be received in any form, including acoustic, speech, or tactile input. In addition, a computer can interact with a test subject or relations by sending documents to and receiving documents from a device that is used by the test subject or relations; for example, by sending web pages to a web browser on a test subject device 130 in response to requests received from the web browser.

Embodiments of the subject matter described herein can be implemented in a computing system that includes a back-end component (e.g., as an information/data server) or that includes a middleware component (e.g., an application server) or that includes a front-end component (e.g., a client computer having a graphical user interface or a web browser) through which a test subject or relations can interact with an implementation of the subject matter described herein, or any combination of one or more such back-end, middleware, or front-end components. The components of the system can be interconnected by any form or medium of digital information/data communication (e.g., a communication network). Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving test subject or relations input from a test subject or relations interacting with the client device). Information/data generated at the client device (e.g., a result of the test subject or relations interaction) can be received from the client device at the server.

While this specification contains many specific implementation details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Many modifications and other embodiments of the disclosure set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

1. A method, comprising:
receiving, by a medical review office (MRO) computer, a request for a first test by a first user computer associated with a first user;
receiving, by the MRO computer, information from a second user computer associated with a second user;
determining, by the MRO computer, one or more testing sites to perform the first test;
receiving, by the MRO computer, a first preference from the second user computer, the first preference comprising a first preferred testing site from the one or more testing sites to perform the first test;
registering, by the MRO computer, the second user at a testing site, the testing site comprising the first preferred testing site to perform the first test or a second testing site from the one or more testing sites to perform the first test;
scheduling, by the MRO computer, a first appointment for the second user at the testing site;
receiving, by a MRO computer, a code from the testing site; and
sending, by a MRO computer, the code to the second user computer.

2. The method of claim 1, wherein the method further comprises receiving, by the MRO computer, a first status information associated with the second user from the testing site.

3. The method of claim 2, wherein the method further comprises presenting, by the MRO computer, the first status information associated with the second user received from the testing site to the first user computer.

4. The method of claim 1, wherein the information received from a second user computer further comprises an identifying information associated with the second user.

5. The method of claim 1, wherein the determining, by the MRO computer, one or more testing sites to perform the first test further comprises determining a location of the second user computer and one or more locations of the one or more testing sites.

6. The method of claim 1, wherein the method further comprises sending, by the MRO computer, a result associated with the first test to a medical review office.

7. The method of claim 1, wherein the method further comprises sending, by the MRO computer, a result associated with the first test to the first user computer.

8. The method of claim 1, wherein the method further comprises generating, by the MRO computer, one or more forms used in the registering of the second user at the testing site.

9. A non-transitory computer-readable medium storing computer-executable instructions which, when executed by a processor, cause the processor to perform operations comprising:
receiving, by the processor, a request for a first test by a first user computer associated with a first user;
receiving, by the processor, information from a second user computer associated with a second user;
determining, by the processor, one or more testing sites to perform the first test;
receiving, by the processor, a first preference from the second user computer, the first preference comprising a first preferred testing site from the one or more testing sites to perform the first test;
registering, by the processor, the second user at a testing site, the testing site comprising the first preferred testing site to perform the first test or a second testing site from the one or more testing sites to perform the first test;
scheduling, by the processor, a first appointment for the second user at the testing site;
receiving, by the processor, a code from the testing site; and
sending, by the processor, the code to the second user computer.

10. The non-transitory computer-readable medium of claim 9, wherein the computer-executable instructions further comprise computer-executable instructions to receive, by the processor, a first status information associated with the second user from the testing site.

11. The non-transitory computer-readable medium of claim 9, wherein the information received from a second user computer further comprises an identifying information associated with the second user.

12. The non-transitory computer-readable medium of claim 9, wherein the computer-executable instructions to determine, by the processor, one or more testing sites to perform the first test further comprise computer-executable instructions to determine a location of the second user computer and one or more locations of the one or more testing sites.

13. The non-transitory computer-readable medium of claim 9, wherein the computer-executable instructions further comprise computer-executable instructions to send, by the processor, a result associated with the first test to a medical review office.

14. The non-transitory computer-readable medium of claim 9, wherein the computer-executable instructions further comprise computer-executable instructions to send, by the processor, a result associated with the first test to the first user computer.

15. The non-transitory computer-readable medium of claim 9, wherein the computer-executable instructions further comprise computer-executable instructions to generate, by the processor, one or more forms used in the registering of the second user computer at the testing site.

16. A screening computer system comprising a medical review office (MRO) computer, the MRO computer further comprising a non-transitory computer-readable medium storing computer-executable instructions which, when executed by a processor, cause the processor to perform operations comprising:
receiving, by the processor, a request for a first test by a first user computer associated with a first user;
receiving, by the processor, information from a second user computer associated with a second user;
determining, by the processor, one or more testing sites to perform the first test;
receiving, by the processor, a first preference from the second user computer, the first preference comprising a first preferred testing site from the one or more testing sites to perform the first test;
registering, by the processor, the second user at a testing site, the testing site comprising the first preferred testing site to perform the first test or a second testing site from the one or more testing sites to perform the first test;
scheduling, by the processor, a first appointment for the second user at the testing site;
receiving, by the processor, a code from the testing site; and
sending, by the processor, the code to the second user computer.

17. The screening computer system of claim 16, wherein the computer-executable instructions further comprise computer-executable instructions to receive, by the processor, a first status information associated with the second user from the testing site.

18. The screening computer system of claim 16, wherein the computer-executable instructions to determine, by the processor, one or more testing sites to perform the first test further comprise computer-executable instructions to determine a location of the second user computer and one or more locations of the one or more testing sites.

19. The screening computer system of claim 16, wherein the computer-executable instructions further comprise computer-executable instructions to send, by the processor, a result associated with the first test to a medical review office.

20. The screening computer system of claim 16, wherein the computer-executable instructions further comprise computer-executable instructions to send, by the processor, a result associated with the first test to the first user computer.
